(19) United States
(12) Patent Application Publication
(10) Pub. No.: US 2024/0000258 A1
(43) Pub. Date: Jan. 4, 2024

(54) LIQUID HEATING APPLIANCES

(71) Applicant: Strix (China) Limited, Guangzhou (CN)

(72) Inventors: Marc Collinson, Ronaldsway (GB); Andrew Paul, Ronaldsway (GB); Joshua Ward, Ronaldsway (GB); Colin Moughton, Ronaldsway (GB)

(21) Appl. No.: 18/035,057

(22) PCT Filed: Nov. 2, 2021
(86) PCT No.: PCT/GB2021/052837

§ 371 Date: May 2, 2023

(30) Foreign Application Priority Data
Nov. 2, 2020 (GB) 2017362.1

(51) Int. Cl. A47J 27/21; H05B 6/10; H05B 6/06

(52) U.S. Cl. CPC A47J 27/21116; A47J 27/21033; A47J 27/21075; A47J 27/21166; H05B 6/108; H05B 6/062; H05B 2213/04

(57) ABSTRACT

A liquid heating appliance for placement on an induction hob includes a liquid vessel, a ferromagnetic heating plate mounted within the vessel by a lifting mechanism, and a thermally sensitive actuator. The lifting mechanism is operable to move the ferromagnetic heating plate upwards within the vessel in response to the thermally sensitive actuator detecting that the heating plate exceeds a predefined temperature.

The present invention relates to liquid heating appliances, in particular to a liquid heating appliance for use with an induction hob.

Liquid heating appliances, such as kettles, are common in many households. Conventional kettles comprise an electrical power supply that is arranged to heat an element at the base of the kettle. It is known to provide a kettle with dry boil protection using a thermally sensitive control comprising one or more thermally sensitive actuators that are mounted in good thermal contact with its heated base. The actuator(s) operate to automatically interrupt the power supply upon detecting an overheat condition e.g. because the appliance has boiled dry or been turned on without any water inside. Such protection mechanisms therefore rely on the accessibility of the power supply.

Induction hobs are becoming increasingly popular in domestic kitchens for the preparation of food and beverages. Induction hobs comprise a coil which, when supplied with an electrical current, generates a magnetic field. Ferromagnetic materials placed within the magnetic field are heated by eddy currents induced within the material by the magnetic field. Typical induction heating vessels (such as pans or kettles) comprise a ferromagnetic component which is arranged in contact with the liquid and heated when the vessel is placed on an energised induction hob, thereby acting to heat the liquid within the vessel.

Induction kettles have already been proposed in which the kettle is predominantly passive like a saucepan, as control of the heating arrangement is provided by the hob, rather than the kettle. This separation of the control arrangement and the kettle presents challenges with regard to automatic temperature control and switch off, and to dry boil protection in particular. Known dry boil protection mechanisms, such as those discussed above, are not suitable for induction kettles. As the power supply is not provided to the kettle itself, an actuator arranged to sense the temperature within the kettle would be poorly positioned to interrupt the power supply to the induction coil in the hob.

The present invention aims to provide an improved appliance and when viewed from a first aspect the present invention provides a liquid heating appliance for placement upon an induction hob, the appliance comprising:
a liquid vessel;
a ferromagnetic heating plate mounted within the liquid vessel
a thermally sensitive actuator in thermal communication with the ferromagnetic heating plate and configured to detect when the temperature of the ferromagnetic heating plate exceeds a predefined temperature; and
a lifting mechanism mounting the heating plate and operable to move the heating plate upwards within the liquid vessel in response to the thermally sensitive actuator detecting that the temperature of the heating plate exceeds the predefined temperature.

It will be appreciated that the present invention provides a “dry switch off” function in which, in response to detecting a predefined temperature of the ferromagnetic heating plate (e.g. indicative of a dry boil scenario), the lifting mechanism is arranged to move the heating plate upwards away from the magnetic field of the induction hob. Thus, even if the induction hob continues to be energised, no further heating of the heating plate will occur. This means that induction heating is automatically interrupted when the heating plate is overheating, without requiring any user intervention. In the context of overheat protection, the thermally sensitive actuator may be configured to detect when the temperature of the ferromagnetic heating plate exceeds a predefined temperature of at least 120° C., 125° C., 130° C., 135° C., or 140° C. The phrase “thermal communication” used herein is intended to mean direct thermal communication (i.e. comprising thermal conduction).

The Applicant has identified that, by separating the dry boil protection of the appliance from the induction hob, the independent, passive nature of the appliance can be maintained, thereby avoiding the need for a complex connection, whether mechanical or electrical, between the kettle and the induction hob. This means that appliances in accordance with the present invention can be suitable for use with domestic induction hobs, without requiring modification of the hob.

The liquid vessel may be any suitable or desired shape, defining a volume for receiving a liquid to be heated. Preferably the liquid vessel is able to safely contain liquid, especially water, when heated to boiling. Preferably the liquid vessel is made from a non-ferromagnetic material. In some embodiments the liquid vessel may be made from a non-ferromagnetic metal, e.g. aluminium, copper or brass. In some embodiments the liquid vessel may be made from a non-metallic material such as plastic, plastic composite (e.g. glass-reinforced plastic), glass, ceramic, etc. Preferably the liquid vessel is transparent or semi-transparent. In a preferred set of embodiments, the liquid vessel is made from glass.

This allows the contents of the liquid vessel to be visible to the user and is capable of withstanding very high temperatures. Temperatures of up to 500° C. may be reached when a ferromagnetic heating plate is inductively heated without being immersed in liquid.

Preferably the liquid vessel comprises a base that is arranged to contact the upper surface of the induction hob. Preferably (e.g. a lower surface of) the base is substantially flat so as to increase stability of the appliance. The liquid vessel may be cylindrical. In some embodiments, the liquid vessel is frustoconical. The liquid vessel may comprise a base (e.g. arranged at a lower end of the vessel relative to an induction hob on which the appliance is placed) and a top opening (e.g. arranged at an upper end of the vessel). In some embodiments, the width (e.g. diameter) of the base is greater than the width (e.g. diameter) of the top opening. This gives the appliance an aesthetically pleasing shape, for example the liquid vessel may have the appearance of a traditional glass jug. However, as will be discussed below, such a geometry can make it difficult for the ferromagnetic heating plate to be installed.

The top opening of the vessel may be configured to receive a removable lid. The top opening (e.g. and, thus, the lid) may be circular. The lid may define an aperture for introducing liquid into the vessel. In some embodiments, the lid is arranged to be removed in order to introduce liquid into the vessel. In some embodiments, the liquid vessel may include a spout. Liquid may be introduced to the vessel through the spout, in addition to or instead of using the top opening that is closed by a lid.

The ferromagnetic heating plate may be made of one or more of iron, cobalt, nickel and their ferromagnetic alloys, e.g. steel. The ferromagnetic heating plate may comprise composite materials e.g. ceramic embedded with ferromagnetic particles. Preferably components of the appliance arranged within the liquid vessel are manufactured from food safe materials so that liquid heated within the liquid vessel may be safely consumed.

In at least some embodiments, the lifting mechanism is arranged to mount the ferromagnetic heating plate from its upper side. This means that the lifting mechanism is arranged to pull the heating plate upwards within the liquid vessel rather than pushing the heating plate upwards from below.

In some embodiments, the lifting mechanism mounting the ferromagnetic heating plate is removable from the liquid vessel. The lifting mechanism (and, in some embodiments, the plunger as described below) may be mounted on a removable lid of the appliance. This can increase the ease with which the vessel may be filled with liquid, and can increase the ease with which the appliance can be cleaned.

The ferromagnetic heating plate may be any suitable or desired shape. For example, the heating plate may be generally square, rectangular or polygonal. In some embodiments, the heating plate is circular. In embodiments in which the vessel defines top opening, the heating plate may be inserted into the vessel through the top opening. In such embodiments, a dimension of the heating plate may be limited by the maximum dimension of the top opening. This means that the surface area of the plate may be limited, which can restrict the effective heating power of the heating plate. The appliance may be arranged to provide between 500 W and 4000 W, e.g. between 2000 W and 3000 W, e.g. around 2200 W of heating power. It will be appreciated that this depends upon the power of the hob on which the appliance is placed.

Preferably the heating plate is substantially planar (i.e. flat). A flat shape allows the plate to be easily and more cheaply manufactured. Furthermore, a flat plate helps to ensure that all of the plate is arranged within, and is therefore heated by, the magnetic field of the induction hob.

In a preferred set of embodiments, the heating plate comprises a major axis and a minor axis. It will be understood that the terms “major axis” and “minor axis” are intended to refer to the axes that extend across the planar portion of the plate (i.e. in a plane perpendicular to the thickness of the heating plate) and that the dimension of heating plate along its major axis is greater than the dimension of the heating plate along its minor axis. Thus, the heating plate may be non-circular.

Rather than being rotationally symmetrical, the heating plate may have rotational symmetry of order two. The major axis and minor axis may be bounded by an outline of the heating plate that is curvilinear (e.g. an elliptical outline) or an outline of the heating plate including both curved portions and linear portions (e.g. an oblong outline). In some embodiments, the heating plate is generally elliptical or oblong. While an elliptical heating plate may have a larger surface area for a given length of the major axis, an oblong heating plate may be easier to manufacture, handle or install.

A non-circular (e.g. oblong) heating plate is particularly advantageous in embodiments in which the liquid vessel comprises a top opening that is smaller than its base. The heating plate may be dimensioned such that the minor axis is less than or equal to the width of the top opening. The major axis, however, can be wider than the width of the top opening if the heating plate is inserted into the vessel in a direction that is approximately collinear with the major axis of the heating plate. The heating plate can then be rotated once it is closer to the (wider) base of the vessel. In this way, a greater surface area of heating plate may be provided for a given top opening size. The greater surface area of the heating plate corresponds to a higher effective heating power of the appliance.

This is considered to be novel and inventive in its own right. Thus, when viewed from a second aspect, the invention provides a liquid heating appliance, the appliance comprising:
a liquid vessel;
a ferromagnetic heating plate comprising a major axis and a minor axis; and
a lifting mechanism mounting the heating plate and operable to move the heating plate within the liquid vessel.

Thus, this aspect of the invention provides a liquid heating appliance in which a heating plate (having a major axis and a minor axis) can be moved by a lifting mechanism. The appliance is preferably for use with an induction hob.

As mentioned above, the ferromagnetic heating plate may be generally elliptical or oblong. In at least some embodiments according to this second aspect of the invention, the liquid vessel comprises a base, arranged at a lower end of the vessel, and a top opening, arranged at an upper end of the vessel, wherein the width of the base is greater than the width of the top opening.

In at least some embodiments according to this second aspect of the invention, the appliance further comprises a thermally sensitive actuator in thermal communication with the ferromagnetic heating plate and configured to detect when the temperature of the ferromagnetic heating plate exceeds a predefined temperature, wherein the lifting mechanism is operable to move the heating plate upwards within the liquid vessel in response to the thermally sensitive actuator detecting that the temperature of the heating plate exceeds the predefined temperature. Furthermore, the heating plate may comprise a heat bridge arranged to conduct heat from one or more portions of the heating plate to the thermally sensitive actuator, wherein the heat bridge extends along the minor axis of the heating plate. This arrangement takes advantage of the more heated regions that are formed along the minor axis due to the non-circular geometry of the heating plate, as is described in more detail below.

There will now be described various features which may be applied, alone or in combination, to embodiments according to either of the first or second aspects of the invention.

In some embodiments, the appliance comprises one or more separators arranged between the heating plate and the base of the liquid vessel. The separator(s) may be arranged to act as a stop between the heating plate and the base of the liquid vessel. The separator(s) may be arranged on the (e.g. upper surface of the base of the) liquid vessel. In some embodiments, the separator(s) are arranged on the (e.g. lower surface of the) heating plate. For example, as described below, the heating plate may comprise a plurality of feet arranged on its underside (i.e. arranged to contact the vessel base to set a separation between the base and the heating plate). In some embodiments, the separator(s) prevent at least a portion of the heating plate from resting directly on the upper surface of the base of the liquid vessel. This provides a gap between the heating plate and the liquid vessel which means that, when liquid is provided in the liquid vessel, the liquid is able to flow beneath the heating plate. This increases the total surface area of the heating plate that can be in contact with liquid within the heating vessel and facilitates convection within the vessel to aid uniform heating of the liquid.

The separator(s) may be arranged to provide a gap between the heating plate and the (base of the) liquid vessel of between 0.5 mm and 3 mm, e.g. between 0.7 mm and 1.2 mm, e.g. 1 mm. The Applicant has identified that such a distance is beneficial as it means that the heating plate is close enough to the induction hob that the effects of induction heating are not diminished, yet far enough from the base of the liquid vessel to encourage liquid to flow around the whole surface area of the heating plate.

In some embodiments, owing to the non-circular shape of the heating plate, the temperature of the plate during induction heating is not uniform; portions of the heating plate may be heated to higher temperatures. Even in those embodiments of the first aspect wherein the heating plate may be circular, if the appliance is not placed centrally on an induction hob then the heating plate will have an uneven heat distribution. This variability makes it difficult to position the thermally sensitive actuator optimally to ensure rapid detection of the highest temperatures across the heating plate. In some embodiments, the heating plate comprises a heat bridge arranged to conduct heat from one or more portions of the heating plate to the thermally sensitive actuator. This can help to reduce the risk of the thermally sensitive actuator failing to detect when a temperature of the heating plate exceeds the predefined temperature.

In some embodiments, the heat bridge extends (across the plane of the heating plate) through the centre of the heating plate. In some embodiments the heat bridge may extend along the major axis of the heating plate. Preferably, the heat bridge extends along the minor axis of the heating plate. In some embodiments the heat bridge extends along the (full) width of the heating plate along the minor axis of the heating plate. The inventors have realised that, when the heating plate comprises a major axis and a minor axis, the hottest regions of the heating plate during induction heating by a circular coil are at the edges of the heating plate along the minor axis. Thus, positioning the heat bridge along the minor axis in this way means that the heat bridge is in direct thermal communication with the hottest regions of the heating plate. This allows the heat of the heating plate in these regions to be conducted along the length of the heat bridge.

The heat bridge may be integral with the heating plate. In some embodiments, the heat bridge is mounted onto a surface of the heating plate. In some preferred embodiments the thermally sensitive actuator is mounted on the heat bridge on an upper side of the heating plate. This means that the thermally sensitive actuator and heat bridge do not interfere with the lower side of the heating plate having only a small separation distance from the base of the vessel, as described above. The heat bridge may be mounted on the heating plate by brazing, soldering or riveting, for example. The heat bridge is preferably welded (e.g. laser beam welded or spot welded) to the heating plate. Preferably the heat bridge has a high thermal conductivity. For example, the heat bridge may be copper or aluminium.

During heating of liquid within the appliance, a layer of vapour may become trapped in an area between the base of the vessel and the heating plate. The vapour layer can act to insulate the heating plate from the liquid within the liquid vessel, which can cause the temperature of this area to increase rapidly, while the temperature of the rest of the plate and the temperature of the liquid remain relatively low. This can cause the thermally sensitive actuator to detect a temperature greater than the predefined temperature and cause the lifting mechanism to move the heating plate in response. This means that the appliance can be turned off before the liquid within the appliance is brought to boiling point (so-called “dry boil interference”).

Thus, in some embodiments, the heating plate defines one or more apertures that extend through the heating plate. The one or more apertures may be evenly spaced around the heating plate. The one or more apertures allow vapour produced beneath the heating plate to dissipate within the liquid vessel, thereby reducing the risk of an insulating layer developing. The apertures can also aid the movement of the heating plate within the liquid vessel when liquid is contained within the liquid vessel, as the liquid is able to flow through the aperture(s) as well as around the perimeter of the plate as the heating plate is moved through the liquid. As a result, a less powerful lifting mechanism may be required. Furthermore, the position of the plate can be more easily reset by the user following movement of the plate by the lifting mechanism.

In at least some embodiments, the one or more apertures are arranged around the thermally sensitive actuator. This can help to ensure that heat is conducted to the thermally sensitive actuator rather than being dissipated through the heating plate.

In some embodiments the thermally sensitive actuator is mounted (e.g. directly) on the heating plate. The thermally sensitive actuator may be mounted (e.g. welded) on an upper surface of the heating plate. The heating plate may comprise a casing mounted on the heating plate so as to seal the thermally sensitive actuator from the liquid within the liquid vessel. In embodiments in which the heating plate comprises a heat bridge, the thermally sensitive actuator may be mounted on the heat bridge (e.g. on an upper side of the heating plate). Thus, in such embodiments, the thermally sensitive actuator is in thermal communication with the heating plate via the heat bridge of the heating plate.

In such embodiments, the heat bridge can be used to conduct heat from the more heated regions of the heating plate towards the thermally sensitive actuator. This increases the range of locations at which the thermally sensitive actuator may be positioned, which increases design freedom for the appliance.

Arranging the thermally sensitive actuator on the (e.g. heat bridge of the) heating plate, rather than elsewhere within the appliance, means that the thermally sensitive actuator is capable of more reliably detecting when the temperature of the heating plate exceeds the predefined temperature.

The thermally sensitive actuator may comprise an electronic temperature sensor (e.g. a thermistor). The thermally sensitive actuator may be configured to send an electrical signal to the lifting mechanism to operate the lifting mechanism.

In some preferred embodiments, the thermally sensitive actuator comprises a bimetallic actuator. The thermally sensitive actuator may be arranged to deflect (e.g. with a snap action) when the thermally sensitive actuator detects that the temperature of the plate exceeds the predefined temperature. The thermally sensitive actuator may be arranged to deflect when the temperature of the thermally sensitive actuator exceeds the predefined temperature.

The lifting mechanism is arranged to move the heating plate upwards i.e. away from the base of the vessel. When the base of the appliance is placed on an energised induction hob, it will be appreciated that moving the heating plate away from the base can cause the heating plate to be moved away from the magnetic field generated by the induction hob so that the heating plate is no longer coupled to the magnetic field of the induction hob. As a result, further heating of the heating plate can be prevented.

In some embodiments, the lifting mechanism is arranged to move the heating plate between a heating position and a non-heating position. In the heating position, the heating plate is arranged adjacent (e.g. within 1.5 mm of) the upper (inside) surface of the base of the liquid vessel. In this position, when the appliance is placed on an induction hob and the hob is energised, the heating plate is positioned within the magnetic field of the induction coil and will therefore begin to be heated. In the non-heating position, the heating plate is moved away from the base of the vessel (e.g. more than 20 mm away). In this position, when the appliance is placed on an energised induction hob, the heating plate is sufficiently separated from the induction hob such that the heating plate is not heated by the magnetic field. Thus, in at least some embodiments, the lifting mechanism is operable to move the heating plate upwards within the liquid vessel by a distance of at least 10 mm, 12 mm, 14 mm, 16 mm, 18 mm or 20 mm. This may be the vertical distance between the heating and non-heating positions of the heating plate.

The lifting mechanism may be arranged to move only a portion of the heating plate upwards. The lifting mechanism may be arranged to tilt the heating plate such that a portion of the heating plate is moved upwards away from the base of the appliance. In this way, the tilted portion of the heating plate can be moved away from the magnetic field generated by the induction hob so that a smaller area of the heating plate is exposed to the magnetic field. This can reduce the effective heating power of the heating plate and limit further heating of the heating plate. However, it is preferable that the lifting mechanism is arranged to move the entire heating plate upwards. This means that the heating plate is moved straight upwards rather than tilting. The heating plate may remain in a generally horizontal orientation while being lifted upwards. This can be a quicker and more reliable way of moving the heating plate away from the magnetic field of the hob.

The lifting mechanism may be arranged on the base of the vessel. In some embodiments, the lifting mechanism is mounted on a lid of the appliance. The lifting mechanism may be arranged to move the heating plate relative to the lid of the appliance.

The lifting mechanism may comprise a plunger by which the heating plate is mounted within the liquid vessel. The heating plate may be mounted (e.g. welded) to the plunger at a lower end of the plunger, such that the plunger extends perpendicularly from the surface of the heating plate. When the heating plate is arranged within the liquid vessel, an upper end of the plunger may extend through the top opening of the liquid vessel (i.e. that is arranged to receive the lid). The lid may define an aperture through which the plunger is arranged to extend.

In some embodiments, the lifting mechanism comprises a lifting biasing member arranged to act on the heating plate to move the heating plate. It will be appreciated that the lifting biasing member operates independently of the thermally sensitive actuator, i.e. the biasing force generated by the lifting biasing member to lift the plate is independent of any movement generated by the thermally sensitive actuator (e.g. due to a shape change upon reaching the predetermined temperature). The lifting biasing member may be arranged to bias (e.g. a portion of) the heating plate away from the base of the appliance. The lifting biasing member may be arranged to act directly or indirectly on the heating plate. In those embodiments wherein the lifting mechanism comprises a plunger, a lifting biasing member may be arranged to act on the plunger so as to move the heating plate. Thus, in some embodiments, the lifting mechanism comprises a plunger mounting the heating plate and at least one lifting biasing member arranged to act on the plunger to move the heating plate. The lifting biasing member may be arranged to act on the plunger at an upper end of the plunger. Of course the lifting mechanism may comprise more than one lifting biasing member, for example a pair of lifting biasing members (such a springs) arranged to act on opposite sides of the plunger. This can help to ensure the plunger is moved upwards without tilting.

In some embodiments, the lifting mechanism comprises a latch, movable between a latched configuration and an unlatched configuration. The latch may be arranged, when in the latched configuration, to restrict movement of the heating plate (e.g. by restricting upwards movement of the plunger). The lifting mechanism may be arranged to move the latch into the unlatched configuration, to allow movement of the heating plate (e.g. by allowing movement of the plunger) in response to the thermally sensitive actuator detecting that the temperature of the heating plate exceeds the predefined temperature. The latch may be arranged to prevent movement of the heating plate (e.g., via the plunger) by the biasing force of the lifting biasing member(s) when the latch is in the latched configuration. In some embodiments the latch may be arranged at the upper end of the plunger.

The lifting mechanism may comprise a latch release part arranged to move the latch between the latched configuration and the unlatched configuration. In some embodiments the latch release part may be arranged at the upper end of the plunger. The latch release part may be pivotally mounted in the appliance such that pivoting movement of the latch release part moves the latch into the unlatched configuration.

The lifting biasing member(s) may be arranged to store potential energy. The lifting biasing member(s) may be arranged to release stored potential energy in response to the thermally sensitive actuator detecting that the temperature of the heating plate exceeds the predefined temperature. The lifting biasing member(s) may comprise a helical (e.g. compression) spring.

The lifting biasing member(s) may be arranged to act on the heating plate directly to move the plate. In some embodiments, the lifting biasing member(s) is arranged to act on the plunger to move the plunger and, thus, the heating plate. Preferably, the plunger is movable by the user to manually reset the position of the heating plate. The position of the heating plate may be manually reset by moving the plunger in the opposite direction to that in which the plunger is arranged to be moved by the lifting mechanism. The plunger may comprise a button by which the plunger can be moved to reset the heating plate. In embodiments in which the lifting mechanism comprises a latch, manual reset of the heating plate preferably moves the latch from the unlatched configuration into the latched configuration.

In some embodiments, the plunger comprises a piston head. The piston head may extend from an outer surface of the plunger. The plunger may comprise a plurality of piston heads (e.g. two). The plurality of piston heads may be equally spaced around a circumference of the plunger. The lifting biasing member(s) may be arranged to act on (e.g. each of) the piston head(s). Equally spacing a plurality of piston heads around the plunger helps to balance the biasing force of the lifting biasing member(s) on the plunger, to increase the ease with which the plunger (and thus the heating plate) is lifted by the lifting mechanism. This can also increase the ease with which the heating plate is returned to its initial positon, against the force of the lifting biasing member(s). In some embodiments, the lifting biasing member(s) is arranged to act on a first surface of the piston head(s) to provide a lifting biasing force acting to move the plunger (and thus the heating plate).

In some embodiments, the appliance comprises a damping mechanism arranged to slow the movement of the heating plate as the heating plate is moved upwards by the lifting mechanism. The damping mechanism may be arranged to slow the movement of the heating plate as the heating plate approaches the “non-heating” position. This can help to increase the lifetime of the components of the appliance, by reducing impact forces caused by movement of the heating plate. This can also help to improve the aesthetic appeal of the appliance.

The damping mechanism may comprise a damping spring arranged to act on a second surface of the piston head(s) (e.g. the opposite side of the piston head(s) to the first surface). The damping spring may be a separate component from the lifting biasing spring(s). In some embodiments, the lifting biasing spring(s) and the damping spring are different portions of a single spring. The biasing/damping spring may be arranged (e.g. threaded) around the piston head(s) such that a lower portion of the spring extends from (and acts on) the first surface of the piston head(s) (i.e. to act as the lifting biasing spring). An upper portion of the spring may extend from (and act on) the second surface of the piston head(s) (i.e. to act as the damping spring).

In various embodiments, the appliance may comprise a manual intervention part for interrupting heating of the heating plate. The manual intervention part may comprise its own lifting means for moving the heating plate. Preferably the manual intervention part is arranged to operate the lifting mechanism (i.e. the same lifting mechanism operable to move the heating plate in response to the thermally sensitive actuator detecting the predefined temperature). This reduces the complexity of the appliance. In some embodiments the manual intervention part may be arranged to operate the lifting mechanism by moving the latch release part (e.g. to move the latch into the unlatched configuration). In some embodiments, the manual intervention part comprises an extension member arranged to act on the latch release part of the lifting mechanism to move the latch to the unlatched configuration.

The manual intervention part may be arranged on the plunger. In some embodiments, the manual intervention part is arranged at the upper end of the plunger. The manual intervention part may comprise a push button, comprising the extension member, movably mounted on the plunger with respect to the latch release part. The push button and the extension member may be arranged such that operation of the push button causes the extension member to act on the latch release part to move the latch to the unlatched configuration.

In various embodiments, the appliance may comprise a steam sensing arrangement, arranged to detect when liquid within the liquid vessel reaches boiling. The appliance may comprise a steam chamber for receiving steam generated by the boiling of liquid within the liquid vessel. The steam chamber may be defined in the lid of the appliance. The steam sensing arrangement may be arranged within the steam chamber. In some embodiments the steam sensing arrangement is arranged at the upper end of the plunger.

The steam sensing arrangement may comprise a steam sensitive actuator (e.g. a bimetallic actuator). The steam sensing arrangement may be arranged to independently lift the heating plate in response to detecting that liquid within the vessel is boiling. In some preferred embodiments, the (e.g. steam sensitive actuator of the) steam sensing arrangement is arranged to operate the lifting mechanism in response to detecting that liquid within the vessel is boiling (i.e. the same lifting mechanism operable to move the heating plate in response to the thermally sensitive actuator detecting the predefined temperature). This reduces the complexity of the appliance. The steam sensing arrangement may be arranged to operate the lifting mechanism by moving the latch release part (e.g. to move the latch into the unlatched configuration). Thus it will be appreciated that the same lifting mechanism may be used to lift the heating plate in response to detecting either that the liquid within the vessel is boiling or that the heating plate has reached the predefined temperature (e.g. indicating a boil dry scenario). However, in some embodiments, separate lifting mechanisms may be provided.

The appliance may comprise one or more intermediary mechanisms for operating the lifting mechanism. In some embodiments the thermally sensitive actuator is arranged to operate the lifting mechanism by acting on an intermediary mechanism. The intermediary mechanism may be arranged to operate the lifting mechanism by moving the latch release part (e.g. to move the latch into the unlatched configuration). This means that the thermally sensitive actuator does not need to be arranged to act (e.g. directly) on the latch (to release the latch), in response to detecting that the temperature of the heating plate exceeds the predefined temperature. The thermally sensitive actuator can therefore be positioned remote from the latch and latch release part of the lifting mechanism. In some embodiments, already described above, the latch and latch release part are arranged at the upper end of the plunger. The thermally sensitive actuator is arranged at the lower end of the plunger where the heating plate is mounted.

The intermediary mechanism may comprise a rod, arranged to be moved (e.g. lifted) by the thermally sensitive actuator. The rod may comprise a first end and a second end. The first end of the rod may be arranged adjacent the thermally sensitive actuator and the second end of the rod may be arranged adjacent the latch release part. The thermally sensitive actuator may be arranged to act on the first end of the rod to cause the second end of the rod to act on the latch release part so as to move the latch into the unlatched configuration. The rod may be hollow. This reduces the weight of the rod, which allows the rod to be moved by the thermally sensitive actuator more easily. The intermediary mechanism may further comprise a lever. The rod may be arranged to act on the latch release part via the lever. The intermediary mechanism may be arranged to convert vertical movement of the rod (e.g. when acted on by the thermally sensitive actuator) into horizontal movement of the latch release part (e.g. to move the latch into the unlatched configuration).

The use of an intermediary mechanism allows the thermally sensitive actuator and the lifting mechanism to be arranged in different parts of the appliance, i.e. separated from one another within the liquid vessel. In embodiments in which the thermally sensitive actuator is arranged on the heating plate, an intermediary mechanism acting between the thermally sensitive actuator and the lifting mechanism allows the lifting mechanism to be located elsewhere in the appliance. This can help to reduce the complexity of the appliance, and to limit the number of components arranged in proximity to the varying temperatures of the heating plate. The intermediary mechanism may be arranged on or in the plunger. In some embodiments the intermediary mechanism is arranged inside the plunger. This can protect the intermediary mechanism from being influenced by liquid in the vessel.

In embodiments in which the thermally sensitive actuator comprises a bimetallic actuator, a deflecting portion of the bimetallic actuator may be arranged to act on the (e.g. rod of the) intermediary mechanism in response to the thermally sensitive actuator detecting that the temperature of the heating plate exceeds the predefined temperature.

In various embodiments, the appliance comprises a plate biasing member arranged to bias the heating plate downwards (e.g. towards the base of the vessel). The plate biasing member may exert a biasing force on the heating plate that pushes the heating plate into engagement with the base of the liquid vessel. This can help to ensure that the heating plate is as close to the induction hob as possible during heating of the heating plate. In embodiments in which the appliance comprises one or more separators arranged to separate the heating plate from the base of the liquid vessel, the plate biasing member can also help to ensure that a precise separation is maintained. In some embodiments the plate biasing member may be arranged to act on the plunger, e.g. at an upper end of the plunger, to bias the heating plate downwards.

In some embodiments, the plate biasing member is arranged to bias the heating plate towards the base of the vessel with respect to the plunger. In some embodiments, the plunger comprises an inner shaft moveable within an outer sleeve surrounding the inner shaft. The inner shaft may be mounted (e.g. welded) to the heating plate. The plate biasing member may be arranged to act on the inner shaft to bias the heating plate downwards. The (e.g. lifting biasing member(s) of the) lifting mechanism may be arranged to act on the outer sleeve to move the heating plate upwards when the lifting mechanism operates.

The latch of the lifting mechanism can ensure that the plunger is held at a given vertical position with respect to the base of the vessel when the heating plate is in its heating position. However, in embodiments in which a plate biasing member is provided to bias the heating plate towards the base of the vessel independently of the plunger, the plate biasing member can help to ensure that the heating plate is pressed close to the base of the liquid vessel, without interfering with the lifting mechanism. The plate biasing member can exert a biasing force on the heating plate without opposing the (e.g. lifting biasing member(s) of the) lifting mechanism.

In some embodiments, the plate biasing member that is arranged to bias the heating plate downwards towards the base of the vessel also serves to upwardly bias the push button of the manual intervention part. The push button of the manual intervention part may be arranged to be pushed down against the bias of the plate biasing member in order to commence manual intervention. This helps to return the manual intervention part to its original position.

The Applicant has identified that the heating plate may be brought into contact with one or more side walls of the vessel. This may occur during operation of the lifting mechanism or while the heating plate is being inserted into or removed from the vessel. There may also be a risk of unintended sideways movement of the heating plate e.g. during transit. For example, a lifting mechanism such as a plunger mounting the heating plate within the liquid vessel can act as a pendulum that causes the heating plate to be brought into contact with a side wall of the vessel.

It can be beneficial to avoid such contact between the heating plate and a side wall of the vessel. Impacts between the heating plate and the vessel can damage the vessel, resulting in the formation of failure points in the vessel. Furthermore, if the heating plate has been heated to a significantly high temperature (e.g. during a dry-boil scenario), physical contact between the heating plate and the vessel can cause thermal shock in the vessel. This can lead to failure of the vessel material, which is naturally a safety concern.

Thus, in some embodiments the appliance comprises a protection component arranged between the ferromagnetic heating plate and a side wall of the liquid vessel. The protection component may be mounted to the heating plate and/or to the lifting mechanism. The protection component is preferably arranged to protect the liquid vessel from coming into contact with the heating plate. Such a protection component is useful for any shape of ferromagnetic heating plate.

This is considered to be novel and inventive in its own right. Thus, when viewed from a further aspect, the invention provides a liquid heating appliance for placement upon an induction hob, the appliance comprising:
a liquid vessel;
a ferromagnetic heating plate mounted within the liquid vessel and spaced from a side wall of the liquid vessel; and
a protection component arranged between the ferromagnetic heating plate and the side wall of the liquid vessel.

In some embodiments, the appliance comprises a lifting mechanism mounting the heating plate. The lifting mechanism may be operable to move the heating plate upwards within the liquid vessel.

The lifting mechanism may be manually operable. In some embodiments, the appliance comprises a thermally sensitive actuator in thermal communication with the ferromagnetic heating plate and configured to detect when the temperature of the ferromagnetic heating plate exceeds a predefined temperature. The lifting mechanism may be operable to move the heating plate upwards within the liquid vessel in response to the thermally sensitive actuator detecting that the temperature of the heating plate exceeds the predefined temperature, as described above.

The side wall is preferably a glass wall. In some embodiments, the (e.g. entire) liquid vessel is a glass vessel.

The ferromagnetic heating plate may have any suitable shape, including circular or polygonal. In some embodiments the ferromagnetic heating plate is non-circular. In some embodiments the ferromagnetic heating plate comprises a major axis and a minor axis. In some embodiments, the heating plate is not rotationally symmetric, as described above. For example, the heating plate may have rotational symmetry of order two. The major axis and minor axis may be bounded by an outline of the heating plate that is curvilinear (e.g. an elliptical outline) or an outline of the heating plate including both curved portions and linear portions (e.g. an oblong outline). In some embodiments, the heating plate is generally elliptical or oblong. While an elliptical heating plate may have a larger surface area for a given length of the major axis, an oblong heating plate may be easier to manufacture, handle or install.

The protection component may extend around a perimeter of the ferromagnetic heating plate. Preferably the protection component is arranged in the same plane and radially outwards of the outer edge of the heating plate (e.g. towards the side wall(s) of the liquid vessel). This means that the protection component is arranged to contact the side wall of the vessel before the heating plate, and preferably the protection component is arranged to prevent the ferromagnetic heating plate from coming into direct contact with the side wall of the vessel. This reduces the likelihood of the vessel being damaged by contact with the heating plate (which can have a very high temperature during and after use).

In some embodiments, in addition or alternatively, the protection component comprises a heating plate cover mounted to the ferromagnetic heating plate. The heating plate cover may be mounted to the heating plate directly or indirectly (e.g. mounted to a stem supporting the plate or to the lifting mechanism, as described above). The heating plate cover may be mounted so as to at least partially cover an upper surface of the heating plate.

Providing a heating plate cover as part of the protection component means that the protection component can be more securely mounted to the heating plate, as it can reduce the likelihood of the protection component becoming dislodged as a result of relative movement between the heating plate and the side wall of the vessel. The heating plate cover may also provide an aesthetic benefit as it can shield the heating plate from the view of a user of the appliance. This may be desirable as the heating plate may become discoloured through use.

The heating plate cover may comprise any suitable or desired material. In some embodiments, the heating plate cover comprises a polymer material. In some embodiments, the heating plate cover comprises stainless steel.

In some embodiments, the heating plate cover is mounted to the heating plate such that it is spaced away from the (e.g. upper surface of the) heating plate. This means that thermal conduction between the heating plate and the heating plate cover is limited, which can be particularly beneficial if the heating plate cover is made from a material with a lower melting point than that of the heating plate.

The heating plate cover may comprise a ferromagnetic material. Thus it will be appreciated that the heating plate cover may be heated when the appliance is placed on an energised induction hob. This may be beneficial in some embodiments. Preferably, however, the heating plate cover is spaced away from the heating plate such that the heating plate does not experience inductive heating as a result of the induction hob, or experiences (e.g. substantially) less inductive heating than the heating plate, when the appliance is placed on an energised induction hob.

Preferably the heating plate cover defines one or more apertures for providing fluid communication between an upper side of the heating plate cover and an underside of the heating plate cover. This allows liquid in the liquid vessel to be exposed to the upper surface of the heating plate. Spacing the heating plate cover away from the heating plate, as described above, can improve convection in the liquid vessel, thereby assisting in uniformly heating liquid in the vessel. The provision of apertures in the heating plate cover (and in the heating plate, as described above) can also facilitate convection within the liquid vessel.

The one or more apertures may have any suitable or desired shape. The aperture(s) may be circular. Preferably the apertures are (e.g. angularly separated) slots. In some embodiments, the total area of the aperture(s) defined in the heating plate cover is greater or equal to than the total area of the aperture(s) defined in the heating plate. This can make it less likely that convection in the liquid vessel is inhibited by the heating plate cover.

The heating plate cover may have any suitable or desired shape. The heating plate cover may have a domed shape, e.g. to accommodate a thermally sensitive actuator in thermal communication with the ferromagnetic heating plate (as described above). In some embodiments, the heating plate cover is substantially flat. Preferably, the heating plate cover is shaped so as to match substantially the contours of the upper surface of the heating plate.

Preferably the protection component comprises a resilient material, e.g. silicone. In some embodiments, the protection component comprises a bumper ring. The bumper ring may be mounted directly on the heating plate. Preferably, however, the bumper ring is mounted on the heating plate cover of the protection component. Mounting the bumper ring on the cover helps to protect the bumper ring from high temperatures induced in the heating plate. In some embodiments, the bumper ring comprises a C-shaped cross-section, defining a horizontal upper lip and a horizontal lower lip, wherein the upper and lower lips are connected by a vertical rim. The upper lip may be arranged on the upper surface of the heating plate cover. The lower lip may be arranged on a lower surface of the heating plate cover. The lower lip may be arranged to space the heating plate cover away from the heating plate. Spacing the heating plate cover away from the heating plate can be beneficial for the reasons described above.

Preferably the (e.g. vertical rim of the) bumper ring extends around the perimeter of the heating plate cover, between the heating plate cover and the side wall of the liquid vessel. Preferably the outer edge of the (e.g. vertical rim of the) bumper ring is arranged radially outwards (towards the liquid vessel) of outer edge of the heating plate. This means that bumper ring contacts the vessel wall before the heating plate, meaning the vessel is less likely to be damaged.

The protection component may comprise an engagement feature for engaging with a corresponding engagement feature on the heating plate. The engagement feature may extend downwards from (e.g. an underside of) the heating plate cover or the bumper ring. The protection component may comprise an engagement feature for engaging with a corresponding aperture in the heating plate so as to secure the protection component to the heating plate. Preferably, the protection component comprises a plurality of engagement features, perimetrically spaced around the protection component, for engaging with a respective plurality of corresponding engagement features in the heating plate.

In some embodiments, the engagement feature(s) extends from (e.g. the upper or lower lip of) the bumper ring. The engagement feature(s) may comprise a rivet or tab arranged to be received in a corresponding aperture or slot. It will be appreciated that the engagement feature(s) and the corresponding engagement feature(s) may be respectively provided on the protection component and the heating plate, or vice versa.

The Applicant has identified that it can be desirable to prevent thermal conduction from the heating plate to the base of the liquid vessel, for reasons similar to those discussed above with regard to the side wall of the vessel. In embodiments of the invention in which the appliance comprises one or more separators (e.g. feet) arranged between the heating plate and the base of the liquid vessel, the separators can provide a thermally conductive path between the heating plate and the base of the vessel.

Thus, in a set of embodiments, the one or more separators are arranged such that, when the appliance is placed on the induction hob and the induction hob is energised to inductively heat the ferromagnetic heating plate, the one or more separators are arranged to abut a region of the ferromagnetic heating plate that is less heated than an inductively heated region of the ferromagnetic heating plate.

This feature is believed to be novel and inventive in its own right. Thus, when viewed from a further aspect, the invention provides a liquid heating appliance for placement upon an induction hob, the appliance comprising:
a liquid vessel, comprising a base;
a ferromagnetic heating plate mounted within the liquid vessel, the heating plate comprising a major axis and a minor axis; and
one or more separators arranged between the heating plate and the base of the liquid vessel;
wherein the one or more separators are arranged such that, when, in use, the appliance is placed on an energised induction hob such that the ferromagnetic heating plate is positioned centrally above the hob and a region of the ferromagnetic heating plate is inductively heated, the one or more separators are located within, or are arranged to abut, a region of the ferromagnetic heating plate that is less heated than the inductively heated region of the ferromagnetic heating plate.

This aspect extends to liquid heating apparatus comprising an induction hob and a liquid heating appliance for placement on the induction hob, the appliance comprising:
a liquid vessel, comprising a base;
a ferromagnetic heating plate mounted within the liquid vessel, the heating plate comprising a major axis and a minor axis; and
one or more separators arranged between the heating plate and the base of the liquid vessel;
wherein the one or more separators are arranged such that, when the appliance is placed on the induction hob such that the ferromagnetic heating plate is positioned centrally above the hob and the induction hob is energised such that a region of the ferromagnetic heating plate is inductively heated, the one or more separators are located within, or are arranged to abut, a region of the ferromagnetic heating plate that is less heated than the inductively heated region of the ferromagnetic heating plate.

It will be appreciated that, by providing the one or more separators so that they are arranged within, or are arranged to abut, a region of the ferromagnetic heating plate that is less heated, in use, than a (more) inductively heated region of the heating plate, the liquid vessel can potentially be protected from high levels of thermal conduction from the heating plate via the separator(s). This can increase the safety of the appliance, as well as its lifetime. The potential reduction in thermal conduction between the heating plate and the base of the vessel may also increase the efficiency of the appliance.

As discussed above, the one or more separators may be arranged to act as a stop between the heating plate and the base of the liquid vessel. The separator(s) may be arranged on the (e.g. upper surface of the base of the) liquid vessel (i.e. such that the separator(s) are arranged to abut the less heated region of the heating plate). Preferably, the separator(s) are arranged on the (e.g. a lower surface of the) heating plate (i.e. such that they are arranged within the less heated region of the heating plate). For example, as described above, the heating plate may comprise a plurality of feet arranged on its underside (i.e. arranged to contact the vessel base to set a separation between the base and the heating plate).

The Applicant has identified that induction hobs typically comprise circular coils, meaning that the heated region of a heating plate placed centrally on an induction hob is typically an annulus extending around the centre of the heating plate. For some non-circular (e.g. elliptical) heating plates, a region of the inductively heated region of the plate may extend (e.g. from the outer edge of a generally annular heated region) to a periphery of the plate. This means that it can be beneficial to arrange the separator(s) more centrally, away from the periphery of the plate. Thus, in some embodiments, the one or more separators are located within, or are arranged to abut, an inner half of the heating plate.

Arranging the separator(s) within, or so that they are arranged to abut, an inner half of the heating plate is considered to be novel and inventive in its own right. Thus, when viewed from a further aspect, the invention provides a liquid heating appliance for placement upon an induction hob, the appliance comprising:
a liquid vessel, comprising a base;
a ferromagnetic heating plate mounted within the liquid vessel; and
one or more separators arranged between the heating plate and the base of the liquid vessel;
wherein the one or more separators are located within, or are arranged to abut, an inner half of the ferromagnetic heating plate.

Thus, for a ferromagnetic heating plate having a width w and a height h, the one or more separators are arranged in, or are arranged to abut, a region of the heating plate that has a width of w/2 and a height of h/2, and a centre that is coaxial with the centre of the heating plate. The Applicant has identified that arranging the one or more separators in this way can reduce the likelihood of the feet being exposed to the inductively heated region of the heating plate in use. This is a counterintuitive arrangement as, for stability, separators (e.g. feet) are typically positioned as widely as possible.

When the induction hob is energised and the appliance is placed on the hob, the less heated region of the heating plate experiences a smaller increase in temperature than the heated region of the heating plate. As discussed above, induction hobs comprise a coil for generating a magnetic field. The heated region of the heating plate is typically directly above the coil of the induction hob. The heated region of the heating plate may comprise a substantially annular region that is coaxial with the centre of the heating plate when the appliance is placed centrally on the induction hob. Preferably, the one or more separators are arranged radially inwards of the annular region.

This means that the separator(s) are positioned in, or are arranged to abut, a region of the heating plate that typically experiences less inductive heating in normal use of the appliance. As a result, the thermal conduction between the heating plate and the base of the liquid vessel can potentially be reduced. This can help to protect the liquid vessel from damage by overheating.

Preferably the one or more separators are evenly angularly spaced around the heating plate or the base of the liquid heating vessel. In some embodiments, the liquid vessel may comprise a glass base. The liquid vessel may comprise one or more glass side walls.

In some embodiments, the one or more separators are separate from the heating plate. The one or more separators may be affixed to the underside of the heating plate and/or to an upper side of the base of the liquid vessel. The separator(s) may be affixed to the heating plate and/or the base of the vessel by any suitable or desired means. In some embodiments, the one or more separators are defined in the heating plate itself. The separator(s) may be defined in (e.g. an upper surface of) the base of the liquid vessel. The separator(s) may be made from any suitable or desired material. In some embodiments, the separator(s) comprise the same material as the heating plate. In some embodiments, the separator(s) comprise the same material as the (e.g. base of the) liquid vessel.

As will be appreciated by those skilled in the art, all aspects of the present invention can, and preferably do, include any one or more or all of the preferred and optional features of the embodiments discussed herein, as appropriate.

Some preferred embodiments of the present invention will now be described, by way of example only, with reference to the accompanying drawings, in which:

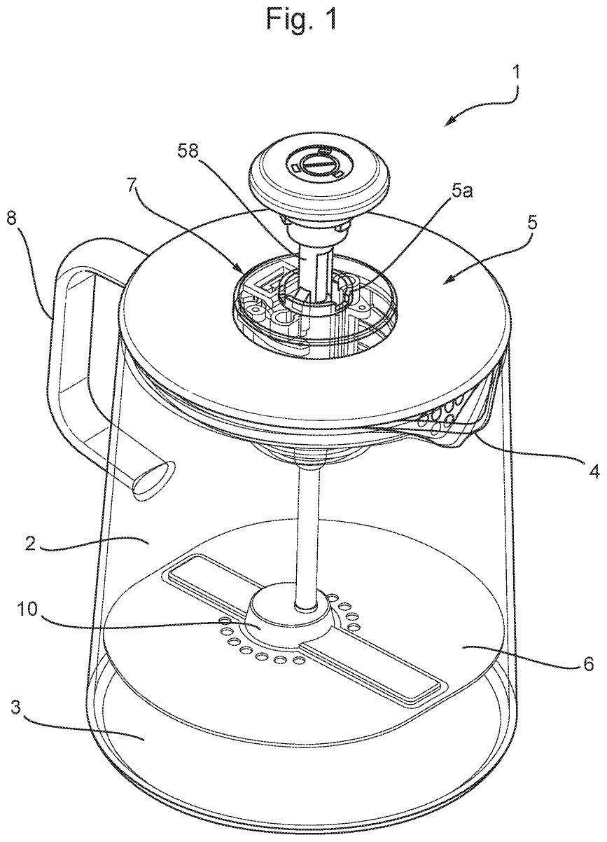

FIG. 1 shows a perspective view of a liquid heating appliance in accordance with an embodiment of the invention;

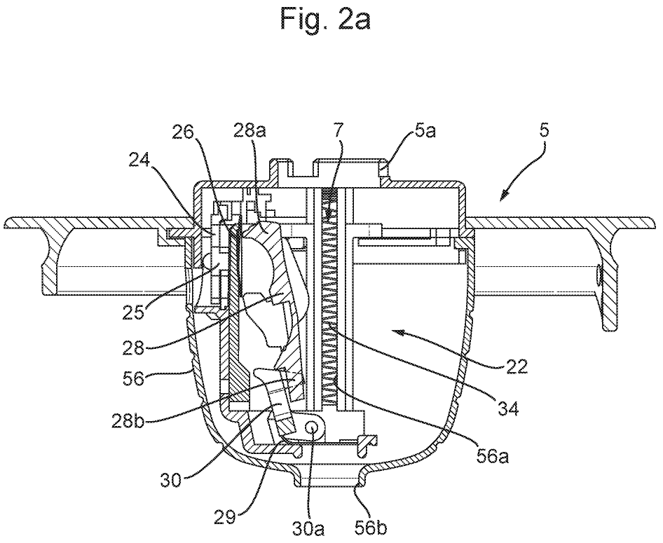

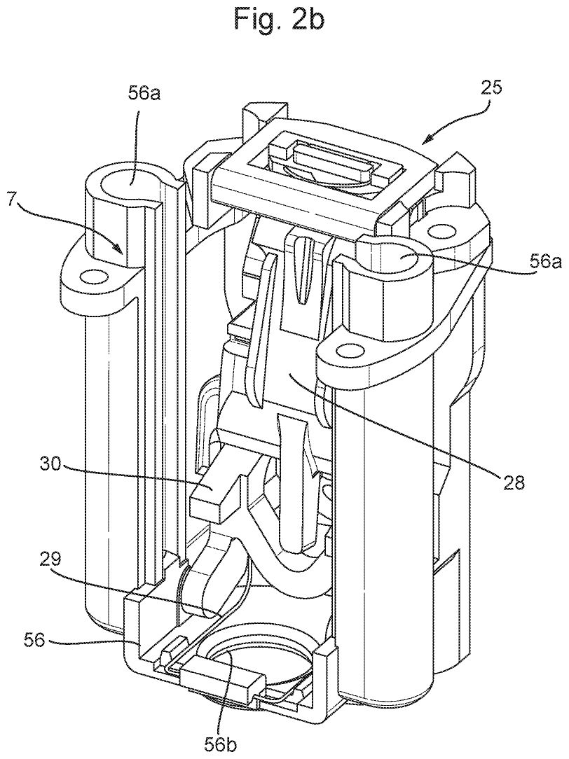

FIG. 2a shows a cross-sectional side view of the lid and the lifting mechanism of the appliance seen in FIG. 1;

FIG. 2b shows a perspective view of portions of the lifting arrangement and the steam sensing arrangement of the appliance seen in FIG. 1;

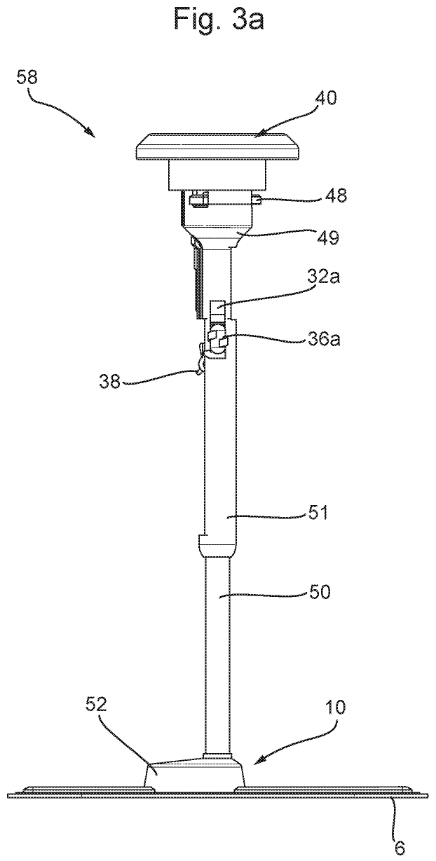

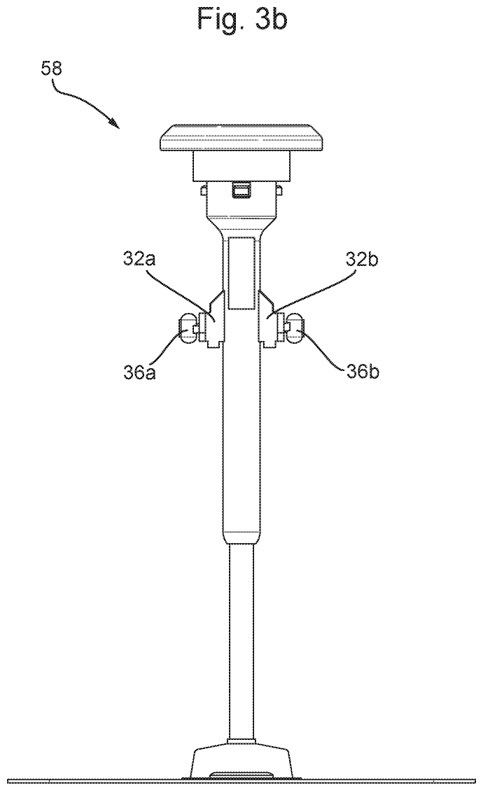

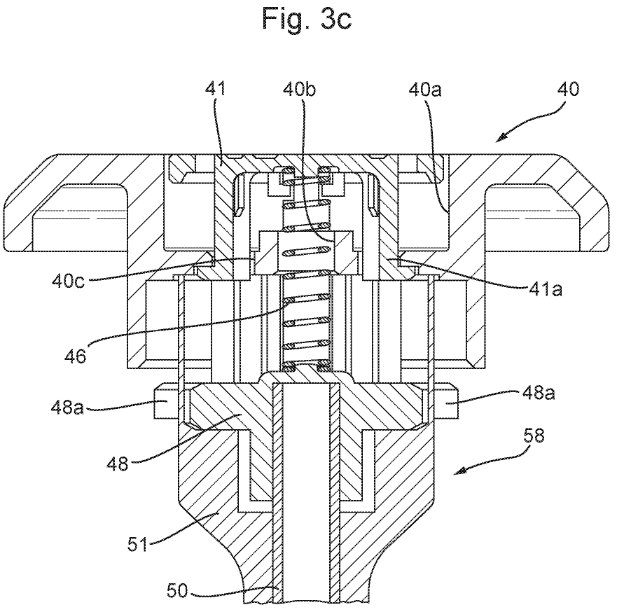

FIG. 3a shows a side view of the plunger and heating plate of the appliance seen in FIG. 1;

FIG. 3b shows a front view of the plunger and heating plate of the appliance seen in FIG. 1;

FIG. 3c shows a first cross-sectional side view of the manual push button of the appliance seen in FIG. 1;

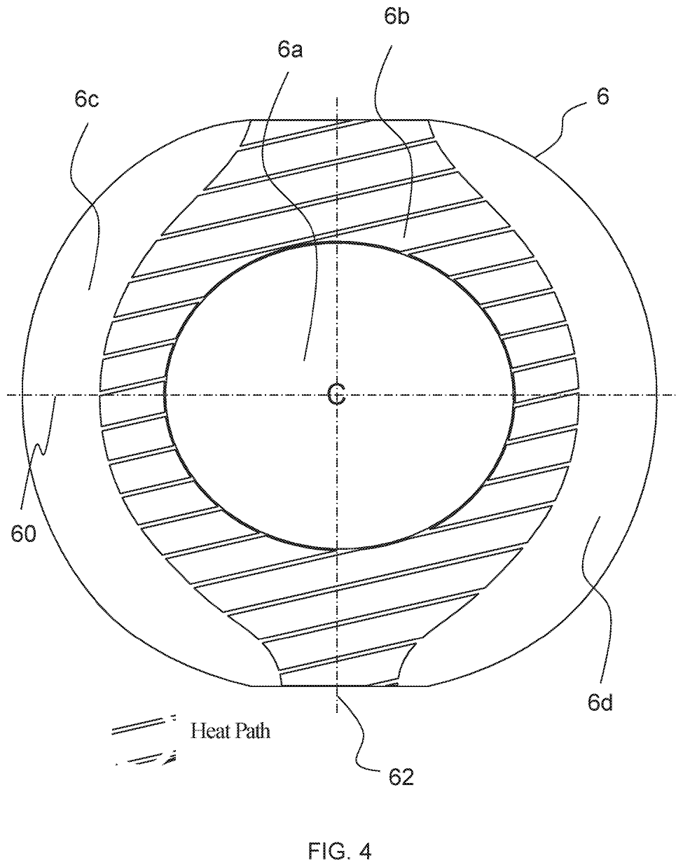

FIG. 4 shows a schematic heat map for an oblong heating plate when placed centrally on an induction hob;

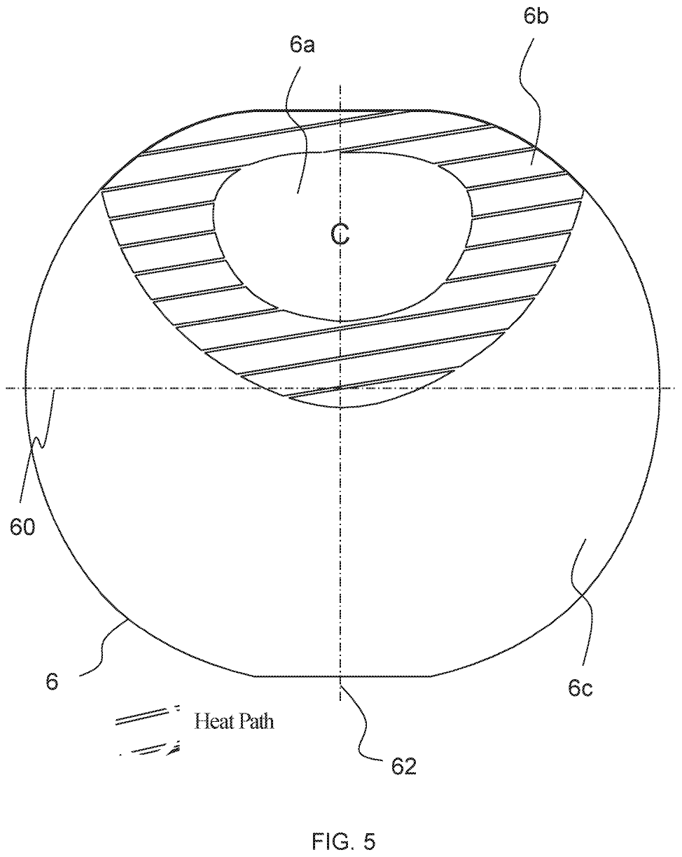

FIG. 5 shows a schematic heat map for the oblong heating plate of FIG. 4 when placed off-centre on an induction hob;

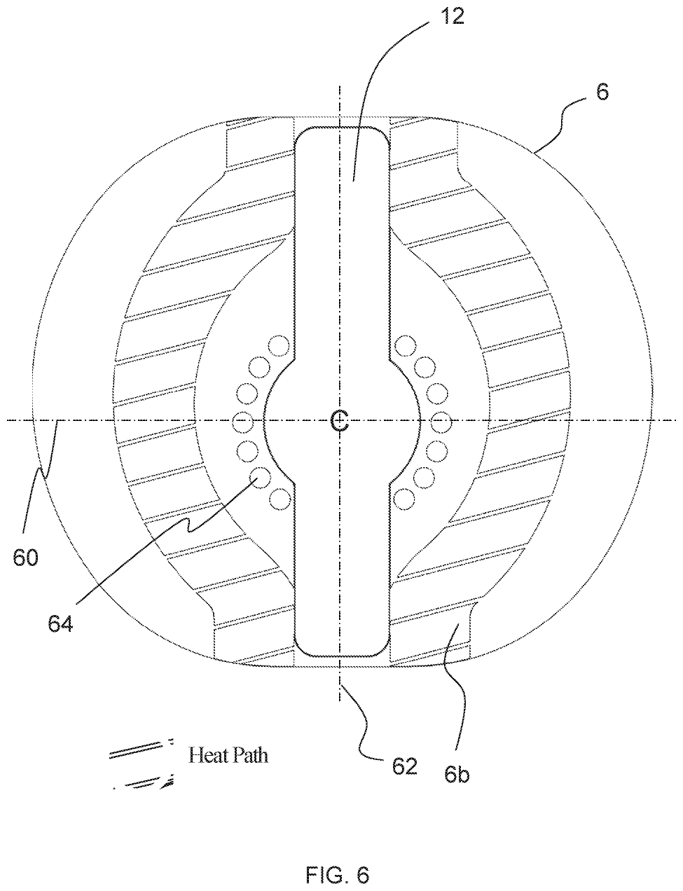

FIG. 6 shows a schematic heat map for the heating plate of the appliance shown in FIG. 1 when the appliance is placed centrally on an induction hob;

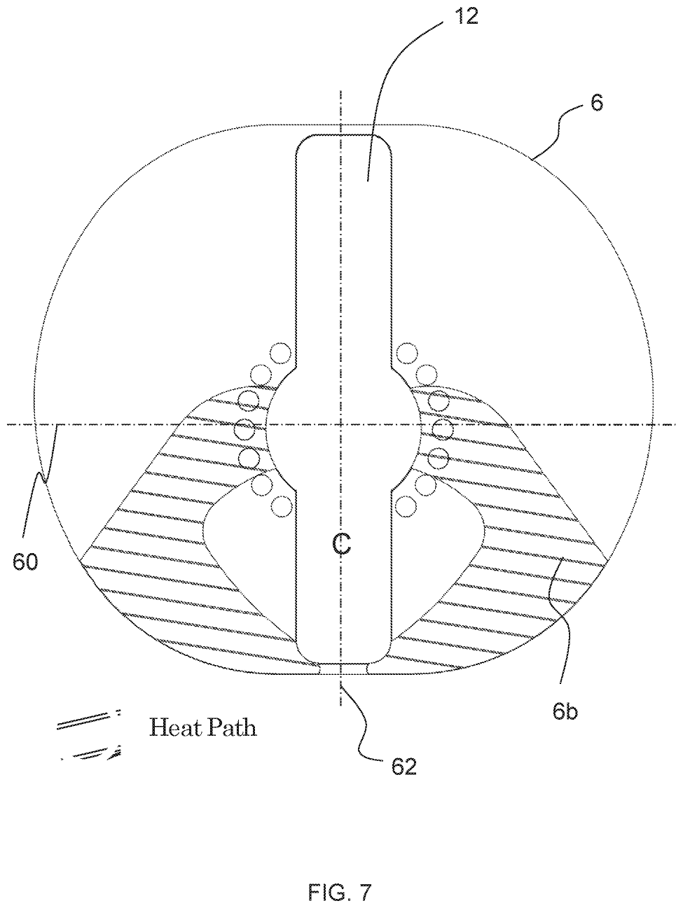

FIG. 7 shows a schematic heat map for the heating plate of the appliance shown in FIG. 1 when the appliance is placed off-centre on an induction hob;

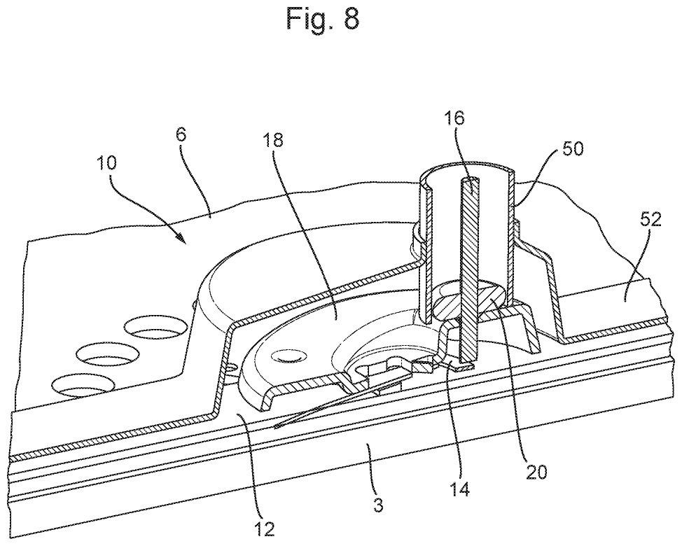

FIG. 8 shows a cross-sectional perspective view of the dry switch off mechanism of the appliance seen in FIG. 1;

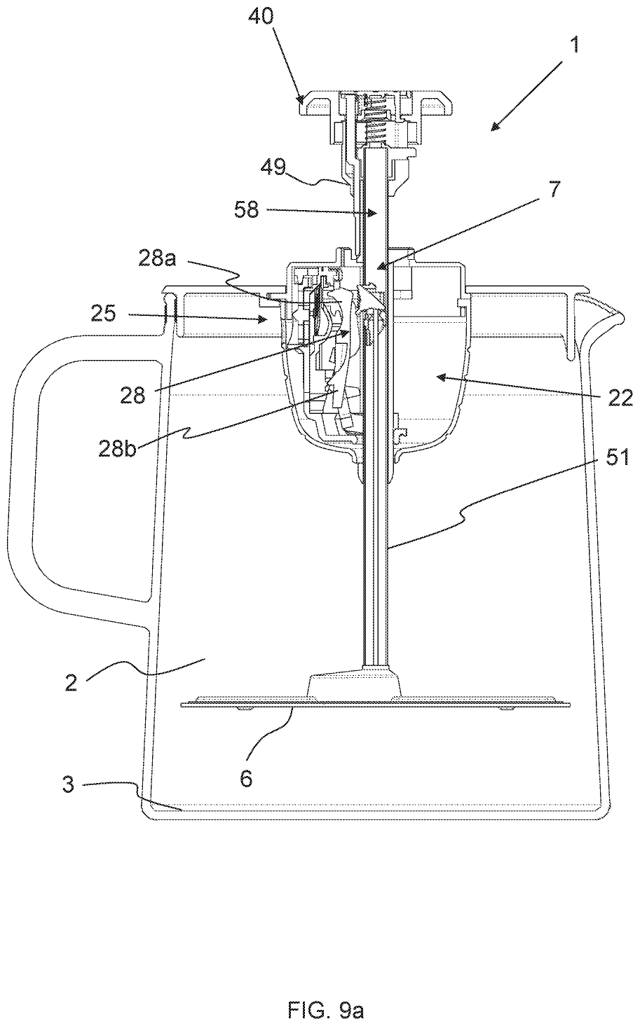

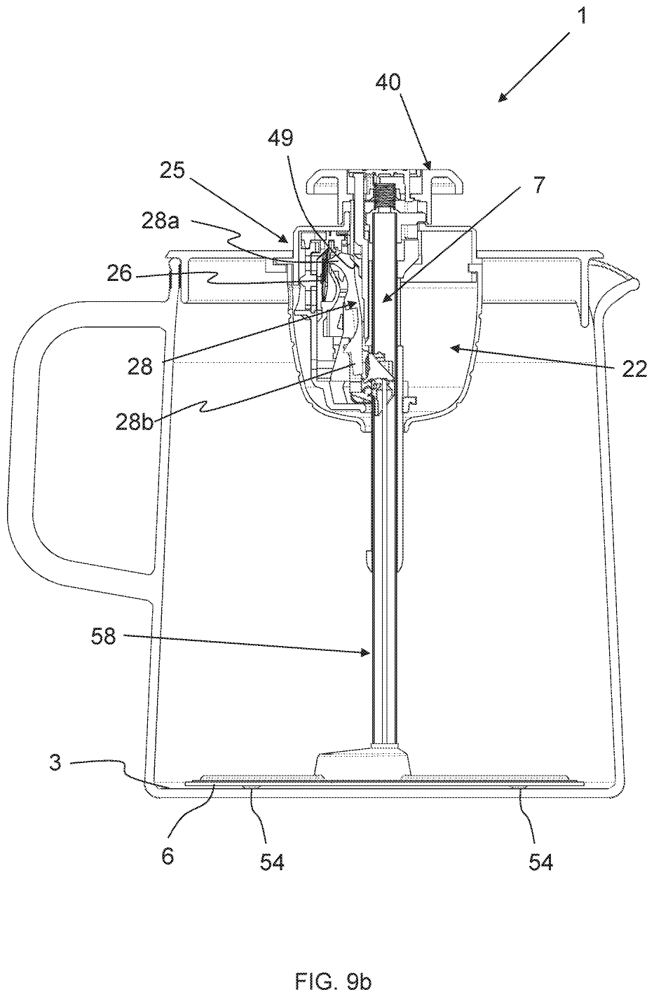

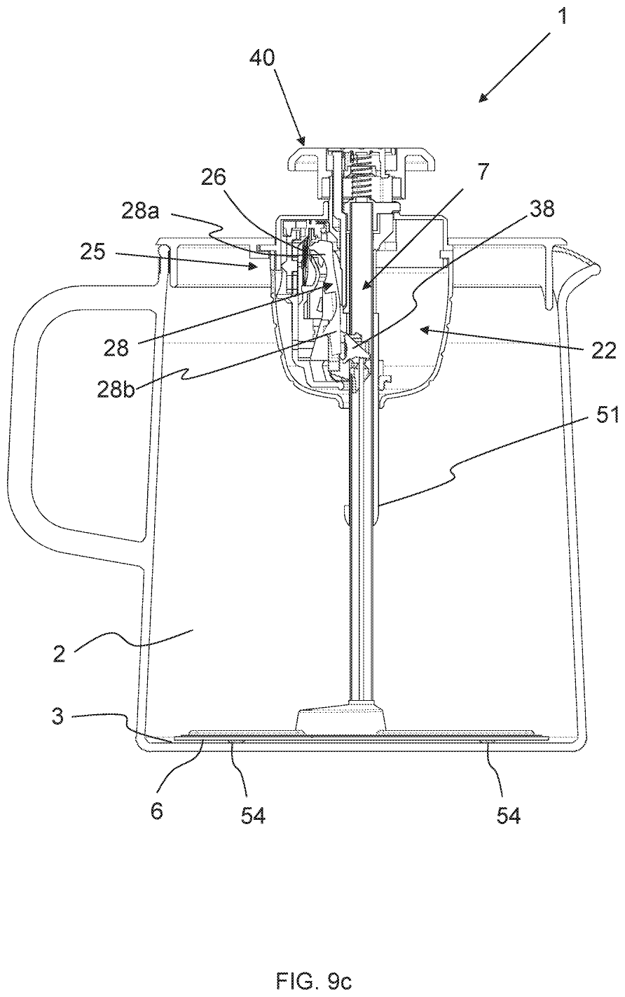

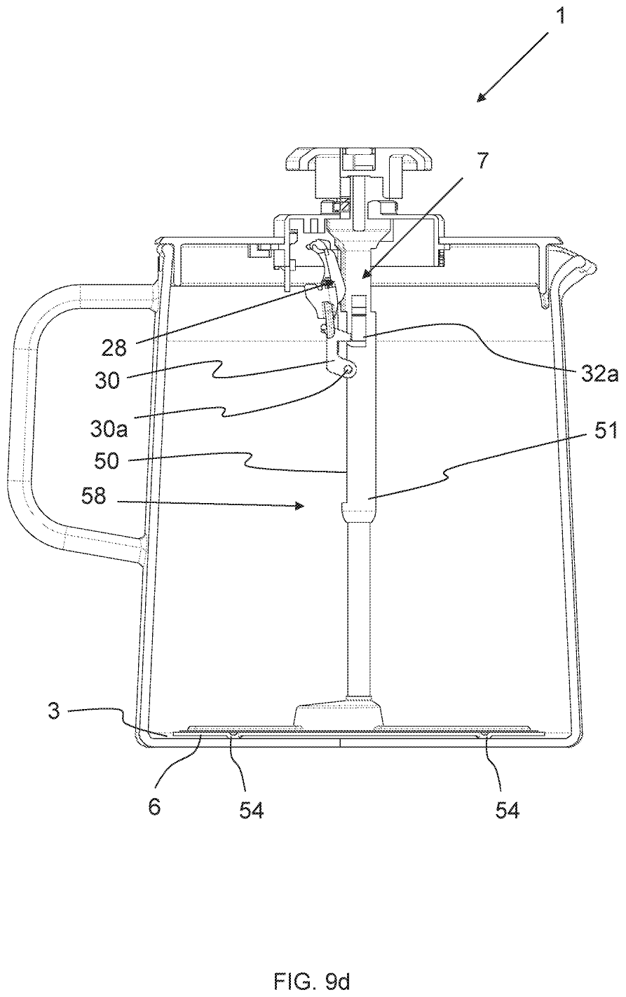

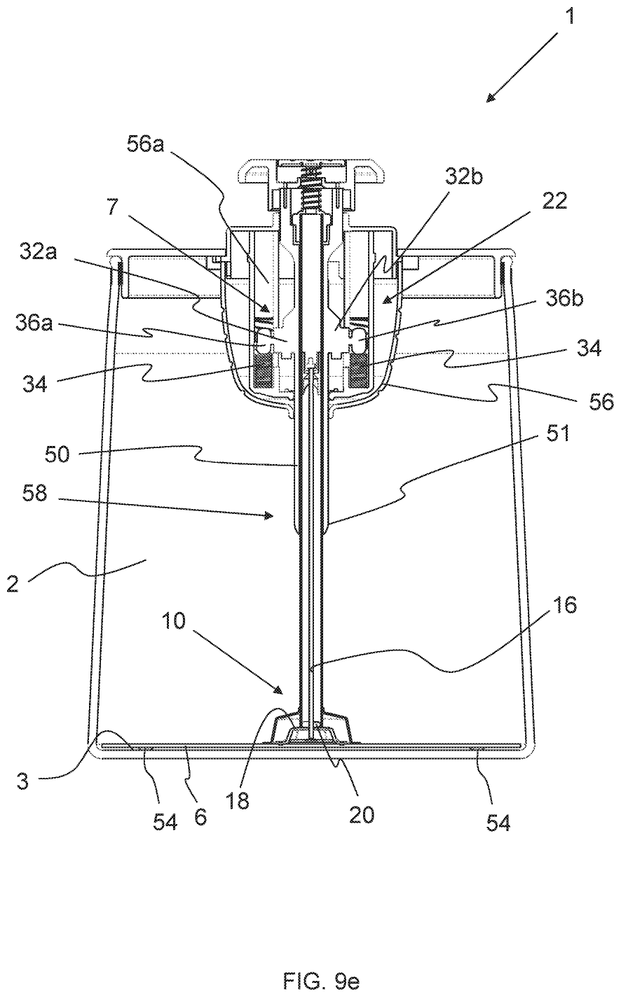

FIG. 9a shows a cross-sectional side view of the appliance seen in FIG. 1 with the heating plate in a non-heating position;

FIG. 9b shows a cross-sectional side view of the appliance seen in FIG. 1 with the heating plate moved downwards by the plunger;

FIG. 9c shows a first cross-sectional side view of the appliance seen in FIG. 1 with the heating plate in the heating position;

FIG. 9d shows a second cross-sectional side view of the appliance seen in FIG. 1 with the heating plate in the heating position;

FIG. 9e shows a cross-sectional front view of the appliance seen in FIG. 1 with the heating plate in the heating position;

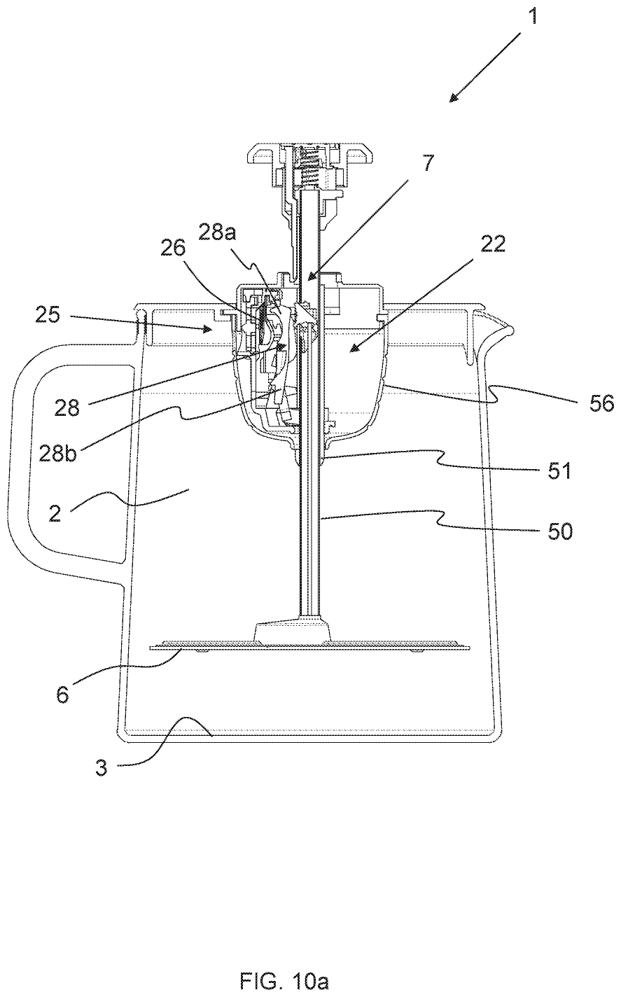

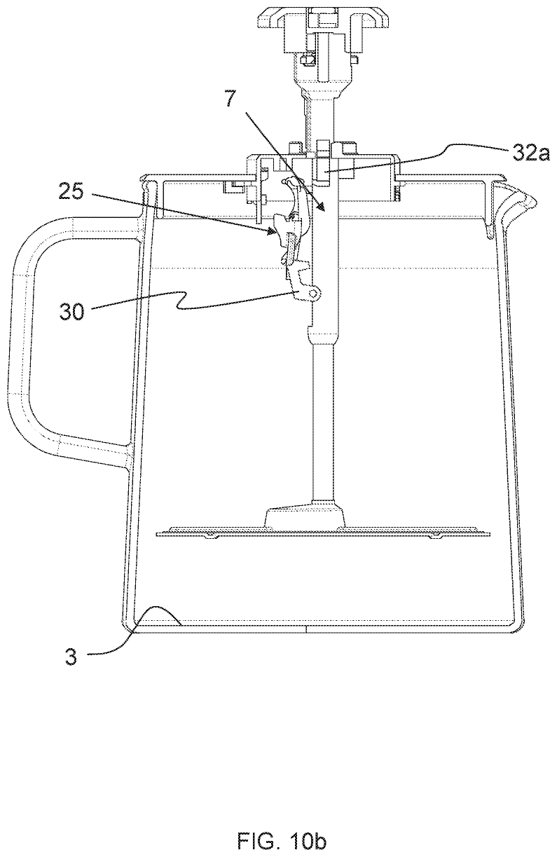

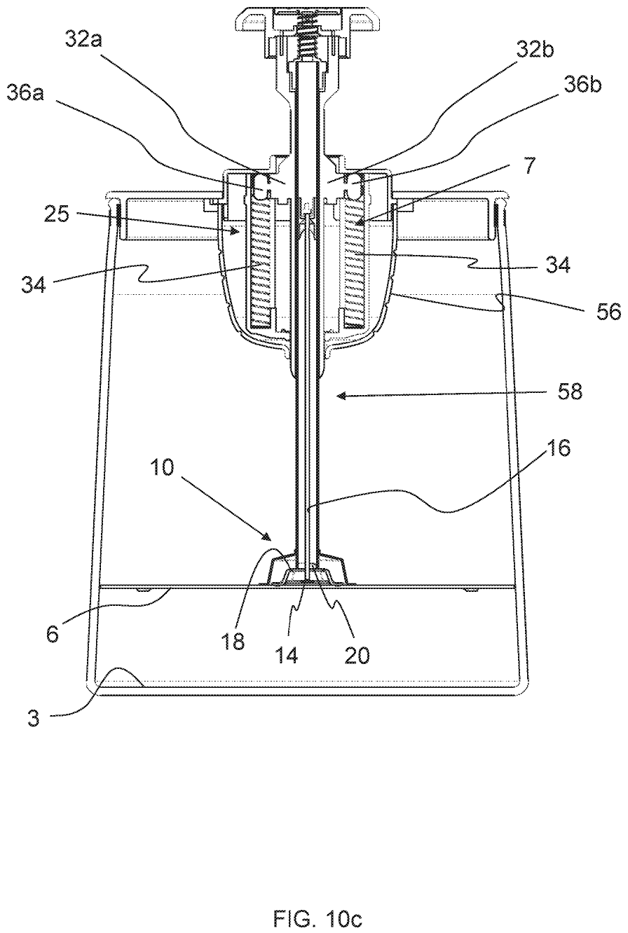

FIG. 10a shows a first cross-sectional side view of the appliance seen in FIG. 1 after the heating plate has been lifted by operation of a steam sensing arrangement;

FIG. 10b shows a second cross-sectional side view of the appliance seen in FIG. 1 after the heating plate has been lifted by operation of the steam sensing arrangement;

FIG. 10c shows a cross-sectional front view of the appliance seen in FIG. 1 after the heating plate has been lifted by operation of the steam sensing arrangement;

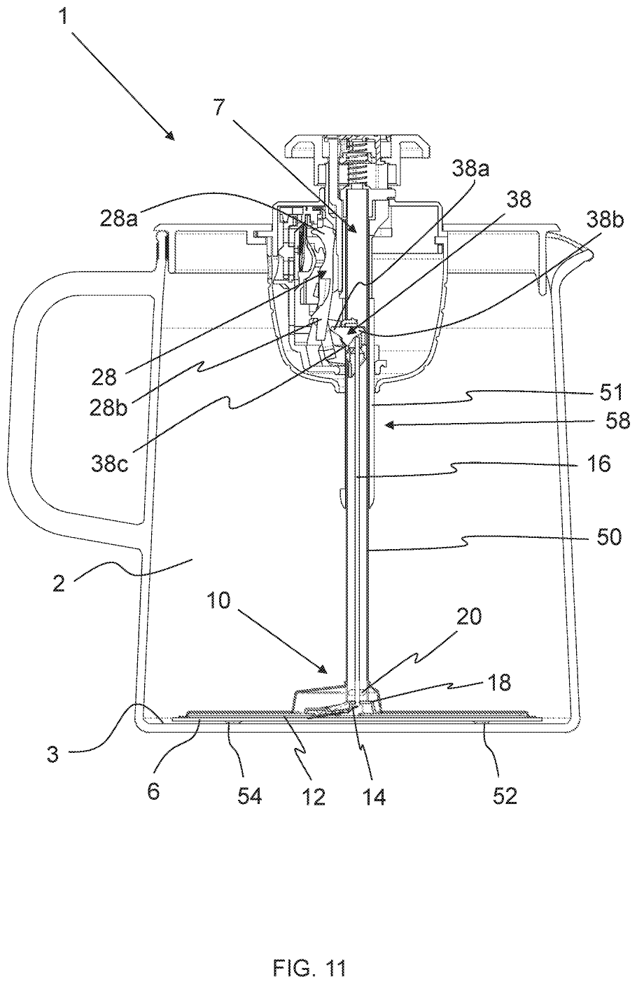

FIG. 11 shows a cross-sectional side view of the appliance seen in FIG. 1 after the dry switch off mechanism has been triggered but before the heating plate has been lifted;

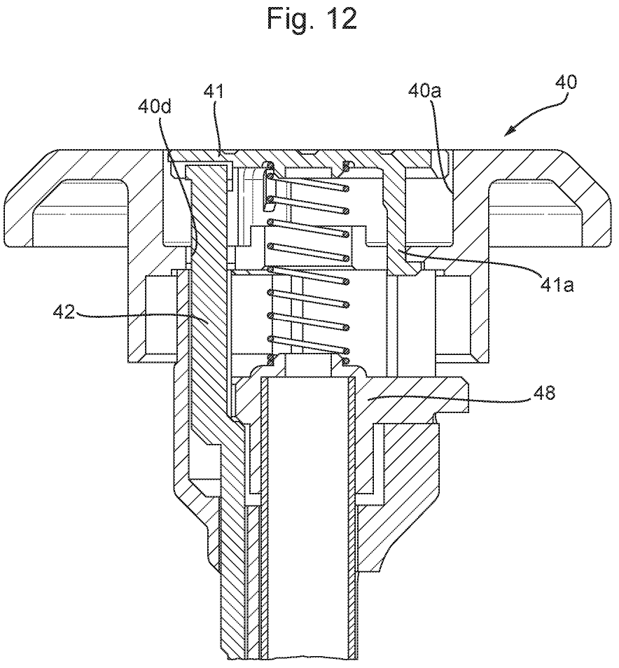

FIG. 12 shows a second cross-sectional side view of the manual push button of the appliance seen in FIG. 1;

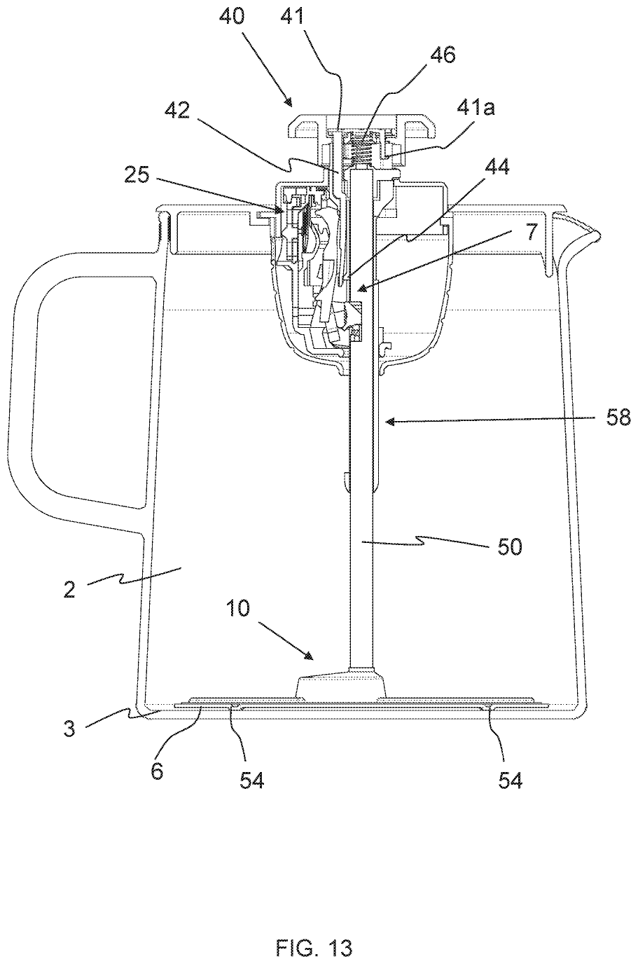

FIG. 13 shows a cross-sectional side view of the appliance seen in FIG. 1 after a manual intervention arrangement has been operated but before the heating plate has been lifted;

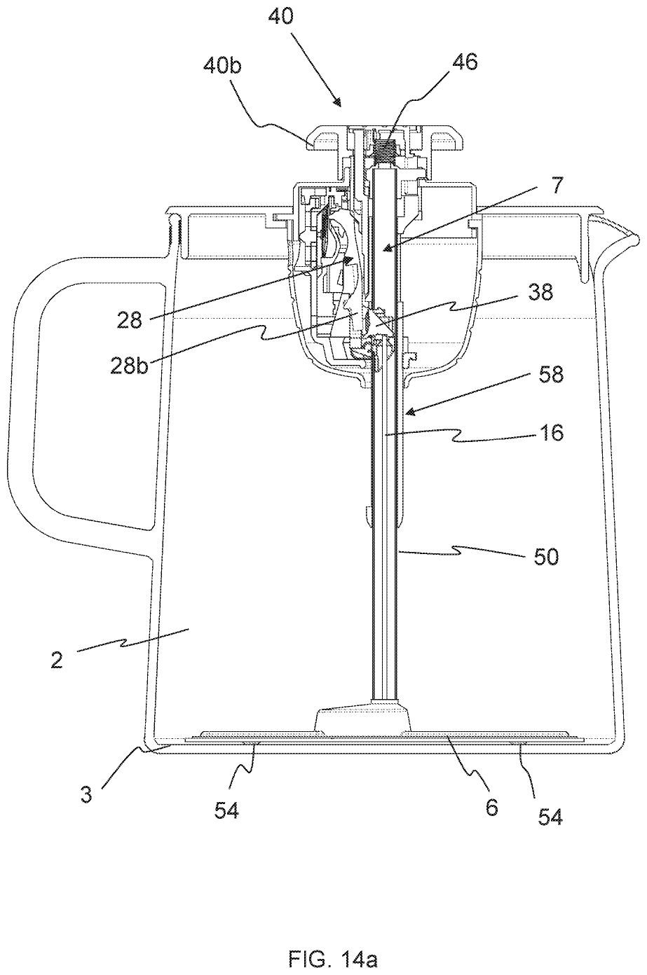

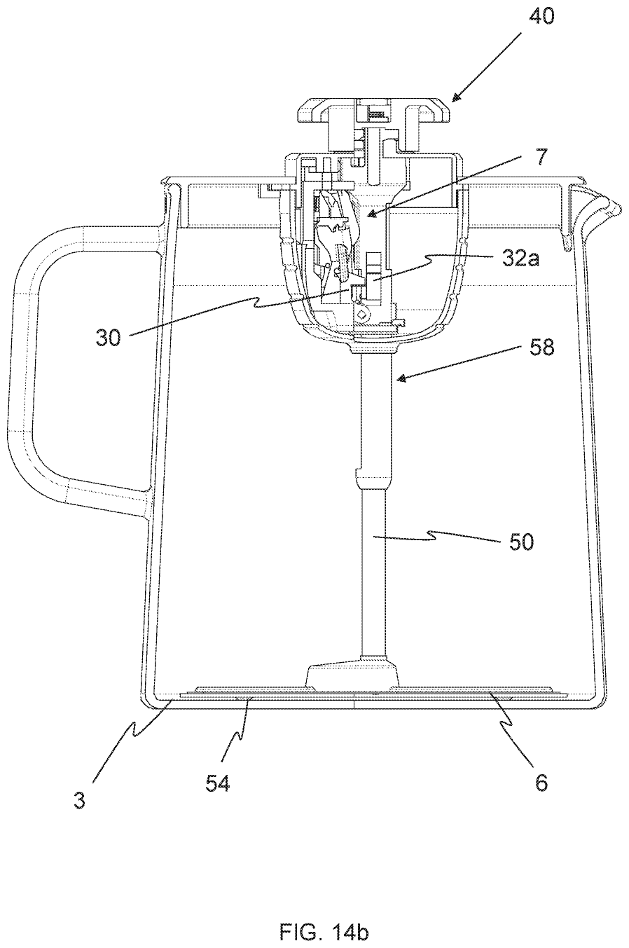

FIG. 14a shows a first cross-sectional side view of the appliance seen in FIG. 1 after a manual reset of the appliance has been operated;

FIG. 14b shows a second cross-sectional side view of the appliance seen in FIG. 1 after the manual reset of the appliance;

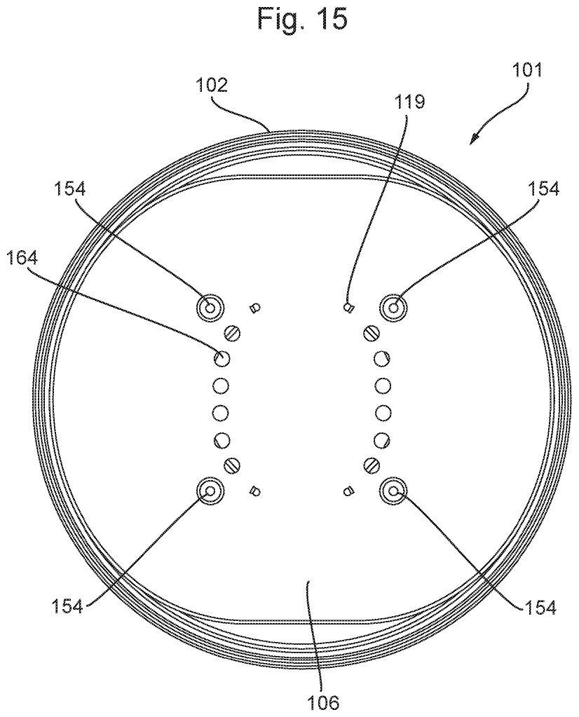

FIG. 15 shows an underside view of a liquid heating appliance in accordance with another embodiment of the invention;

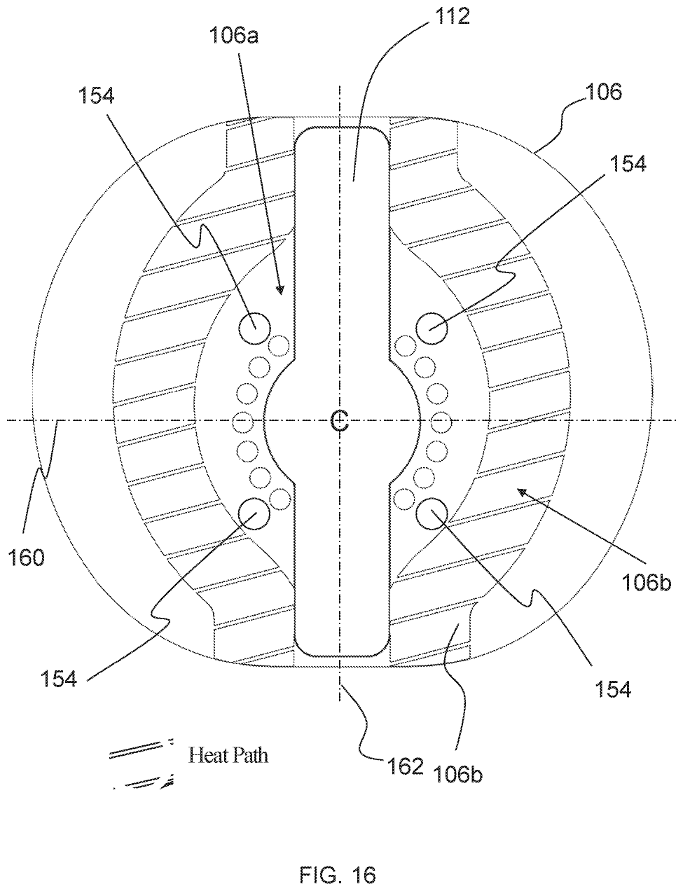

FIG. 16 shows a schematic heat map for the heating plate of the appliance seen in FIG. 15;

FIG. 17 shows a perspective view of the liquid heating appliance seen in FIG. 15;

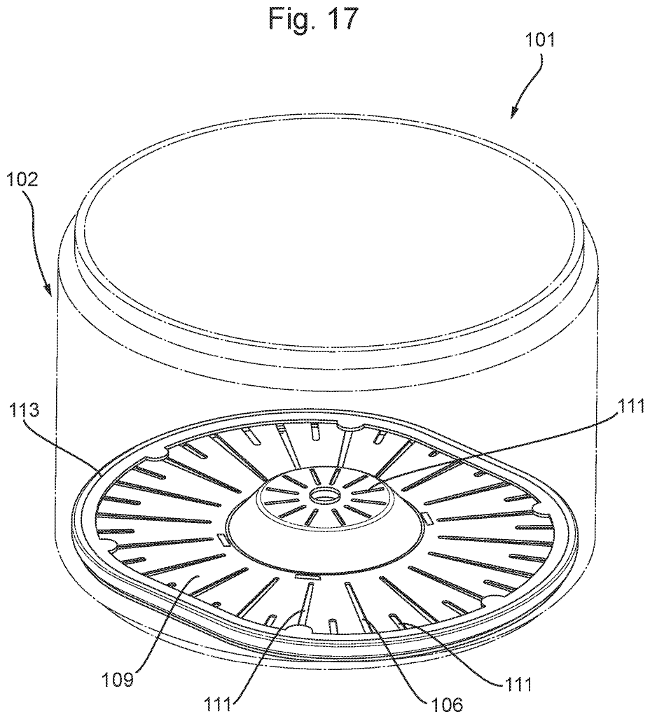

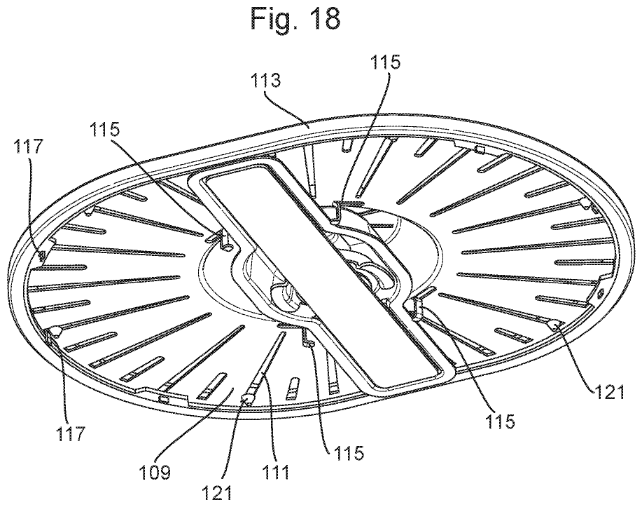

FIG. 18 shows a perspective view of the underside of the heating plate cover of the appliance seen in FIG. 15; and

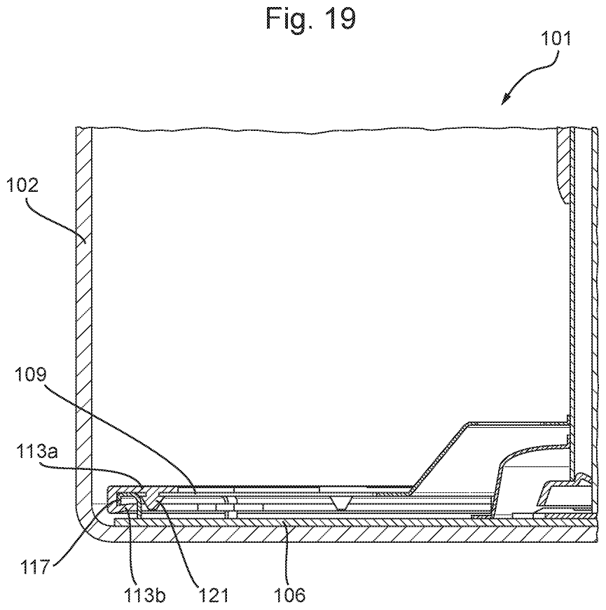

FIG. 19 shows a cross-sectional side view of the appliance seen in FIG. 15.

FIG. 1 shows a perspective view of a liquid heating appliance 1, hereinafter the appliance 1, in accordance with an embodiment of the invention. The appliance 1 comprises a transparent glass housing that defines a liquid vessel 2 including a spout 4. The appliance 1 may be placed directly onto an induction hob (not shown) during use. The vessel 2 comprises a handle 8 for lifting the appliance. The vessel 2 is substantially frustoconical, having a circular base 3 and a circular top. The circumference of the circular top, from which the spout 4 extends, is smaller than the circumference of the base 3 and defines a circular aperture for receiving a circular lid 5.

The appliance 1 further comprises a lifting mechanism 7 mounting a ferromagnetic (e.g. steel) heating plate 6 and operable to move the heating plate 6 within the liquid vessel 2. One of the main components of the lifting mechanism 7 is a plunger 58 that extends from above the lid 5, through a central aperture 5a defined by the lid 5, into the liquid vessel 2 (when the lid 5 is arranged on the vessel 2). The heating plate 6 is welded to a lower end of the plunger 58. It can be seen that the heating plate 6 is non-circular, having a generally oblong outline defining a major axis and a minor axis (described below with reference to FIGS. 6 and 7). The minor axis of the heating plate 6 is approximately equal to the diameter of the circular top opening that receives the lid 5, meaning that the heating plate 6 can be installed through the circular top opening when tilted.

If the heating plate 6 were circular instead, the diameter of the plate 6 (and thus the surface area of the 6) would be limited by the diameter of the circular top opening, as it would not be possible to insert a larger plate 6 through the opening into the liquid vessel 2. However, with an oblong heating plate 6, it will be appreciated that the plate 6 can extend further along its major axis (thus providing a larger surface area), yet still be insertable into the vessel 2 by aligning the minor axis of the heating plate 6 to be parallel with the plane of the circular aperture, and then rotating the plate 6 about its minor axis as it is lowered inside the liquid vessel 2. A greater surface area of the heating plate 6 corresponds to a greater heating power, as a greater area of the plate 6 is exposed to the magnetic field and is thus heated by the induction hob.

The lifting mechanism 7 is arranged to move the heating plate 6 between a heating position (seen in FIG. 1) and a non-heating position wherein the heating plate 6 is lifted away from the base 3 of the vessel 2 (seen in FIGS. 10a-c) and hence away from the magnetic field of an induction hob on which the appliance 1 is placed, so that it experiences no further heating by induction. The plunger 58 is mounted within the aperture 5a such that the plunger 58 can move vertically to lift the heating plate 6 between the heating and non-heating positions.

The appliance 1 further comprises a dry switch-off (DSO) mechanism 10 arranged on the heating plate 6 at the base of the plunger 58 to interact with the lifting mechanism 7. When the liquid vessel 2 is filled with a liquid and the heating plate 6 is heated, the temperature of the DSO mechanism 10 and of the liquid is broadly limited to the boiling temperature of the liquid (e.g. 100° C. when the liquid is water). However, if no liquid is present in the liquid vessel 2, the temperature of the heating plate 6 can rapidly rise to dangerous levels if the appliance 1 is not removed from the hob. This is referred to as “dry boil”. The glass vessel 2 of the appliance 1 will typically be capable of withstanding temperatures of up to 560-600° C. If not for the DSO mechanism 10, some areas of the heating plate 6 could exceed these temperatures during a dry boil situation.

As will be described in more detail below, the DSO mechanism 10 is configured to detect a “dry boil” scenario and to interrupt induction heating of the appliance 1 in response, before any part of the heating plate 6 reaches a dangerous temperature.

FIG. 2a shows a cross-sectional side view of the lid 5 of the appliance 1 seen in FIG. 1. For ease of illustration, other components of the appliance 1 have been removed.

The circular lid 5 is shaped to be received within the circular top opening of the glass vessel 2 of the appliance 1. Thus, the circumference of the lid 5 is approximately equal to the circumference of the opening defined by the top of the vessel 2. The lid 5 comprises a steam chamber housing 56 that extends from the underside of the lid 5 into the liquid vessel 2 (when the lid 5 is arranged on the vessel 2). The steam chamber housing 56 contains various components of the lifting mechanism 7, as will be described further below.

A steam chamber 22 is defined within the steam chamber housing 56. The steam chamber housing 56 further defines a steam inlet 24, which provides fluid communication between the liquid vessel 2 and the steam chamber 22. The steam chamber 22 is arranged to receive, via the steam inlet 24, steam generated during boiling of the liquid within the liquid vessel 2. The steam leaves the steam chamber 22 via the central aperture 5a.

A steam sensing arrangement 25 is arranged within the steam chamber 22 and comprises a bimetallic steam sensor 26, a latch release part (in this embodiment, an armature) 28 and a latch arm 30. The bimetallic steam sensor 26 is arranged within the steam chamber 22 adjacent the steam inlet 24. The bimetallic steam sensor 26 is arranged such that it snaps (i.e. deflects) once it reaches a predefined temperature due to the presence of steam in the chamber 22 indicating that liquid within the liquid vessel 2 has started to boil. In this exemplary embodiment, the appliance 1 is used to boil water, so the predefined temperature for the bimetallic steam sensor 26 is about 85° C. The bimetallic steam sensor 26 is arranged such that deflection of the bimetallic steam sensor 26 causes a free end (the upper end as illustrated in FIG. 2a) of the bimetallic steam sensor 26 to move towards the centre of the steam chamber 22.

The armature 28 of the steam sensing arrangement 25 is pivotally mounted within the steam chamber 22. The armature 28 comprises an upper end 28a and a lower end 28b. The armature 28 is arranged such that it pivots about a point between the upper end 28a and the lower end 28b. The upper end 28a of the armature 28 is arranged adjacent the bimetallic steam sensor 26 such that, when the bimetallic steam sensor 26 deflects, the free end of the bimetallic sensor 26 pushes the upper end 28a of the armature 28 towards the centre of the steam chamber 22. This causes the armature 28 to pivot, thereby moving the lower end 28b of the armature away from the centre of the steam chamber 22.

The latch arm 30 of the steam sensing arrangement 25 is mounted on a pivot 30a on the steam chamber housing 56. The latch arm 30 is arranged to abut the lower end 28b of the armature 28 such that, when the armature 28 pivots as a result of deflection in the bimetallic steam sensor 26, the latch arm 30 is pivoted away from the centre of the steam chamber 22. A wire spring 29 (shown more clearly in FIG. 2b) is provided on the steam chamber housing 56 to ensure intimate engagement between the pivot arm 30 and the lower end 28b of the armature 28.

When the temperature of the bimetallic steam sensor 26 reduces such that the bimetallic steam sensor 26 returns to its ‘non-deflected’ position, and the armature 28 is returned to its original position (as will be described in more detail below) the biasing force of the wire spring 29 on the latch arm 30 allows the latch arm 30 to move with the armature 28 as it returns to its initial position (i.e., the latch arm 30 and the lower end 28b of the armature 28 are moved back towards the centre of the steam chamber 22 together).

Referring to both FIGS. 2a and 2b, the steam chamber housing 56 further defines a lower aperture 56b, arranged to receive the plunger 58 (not seen in FIG. 2a). Thus, the plunger 58 extends from the upper side of the lid 5 into the central aperture 5a, through the steam chamber 22, and out of the lower aperture 56b (into the liquid vessel 2 when the lid 5 is arranged on the vessel 2).

The steam chamber housing 56 further defines two main spring chambers 56a, in which two lifting biasing members (in this embodiment, main springs) 34 are respectively arranged. The second main spring 34 and second main spring chamber 56a are separated from the first main spring 34 and first main spring chamber 56a by 180° around the centre of the steam chamber 22. Thus, only the first of the main springs 34 and main spring chambers 56a are shown in the cross-sectional view of FIG. 2a. Both of the main spring chambers can be seen more clearly in FIG. 2b, and both of the main springs 34 can be seen more clearly in FIG. 9e.

FIG. 2b shows a perspective view of a portion of the lifting mechanism 7 and a portion of the steam sensing arrangement 25. The view shown in FIG. 2b shows more clearly the lower aperture 56b defined in the base of the steam chamber housing 56, both of the main spring chambers 56a, and the wire spring 29. The wire spring 29 is mounted on the spring chamber housing 56 and is arranged to provide a biasing force to the latch arm 30 that ensures intimate engagement of the latch arm 30 with the lower end 28b of the armature 28 as the armature is pivoted. Essentially, the wire spring 29 ensures that the latch arm 30 is always moved (in contact) with the armature 28.

FIG. 3a shows a side view of the plunger 58 and the ferromagnetic heating plate 6. The plunger 58 comprises a steel casing 52, at the lower end of the plunger 58. An upper surface of the heating plate 6 is welded to a lower surface of the casing 52. The casing 52 houses the DSO mechanism 10.

The plunger 58 further comprises a hollow shaft 50 extending vertically upwards from an upper surface of the casing 52 along an axis that is perpendicular to the plane of the heating plate 6 and intersects the centre of the plate 6 in this embodiment. However, it is envisaged that the plunger 58 could alternatively mount the heating plate 6 in an off-centre arrangement and lift the heating plate 6 in a cantilever fashion. The upper end of the shaft 50 is fixedly attached to a supporting member 48. The plunger 58 further comprises a shaft sleeve 51, through which the shaft 50 extends. The shaft 50 is moveable with respect to the shaft sleeve 51, as will be described in more detail below. The plunger 58 further comprises a manual push button 40 at its upper end, which is shown in more detail in FIG. 3c and is described below. The shaft sleeve 51 defines an inclined surface 49 arranged to abut the upper end 28a of the armature 28 when the plunger 58 is moved downwards towards the base of the liquid vessel 2, as will be described in more detail below.

The plunger 58 further comprises a first latch 32a and a first piston 36a, which extend radially from the outer surface of the shaft sleeve 51 in a first direction. A second latch 32b and a second piston 36b extend radially from the outer surface of the shaft sleeve 51 in a second direction, diametrically opposed to the first direction. In other words, the first latch 32a and the first piston 36a are separated from the second latch 32b and the second piston 36b by 180°. Only the first latch 32a and the first piston 36a can be seen in FIG. 3a. The latches 32a, 32b and pistons 36a, 36b can be seen more clearly in FIG. 3b.

The lifting mechanism 7 further comprises a DSO lever 38, the operation of which will be described in more detail below. The DSO lever 38 is pivotally mounted within the shaft 50, and partially protrudes from an aperture in the shaft sleeve 51. In use (when the plunger 58 is arranged within the liquid vessel 2), the DSO lever 38 protrudes from the shaft sleeve 51 towards the steam sensing arrangement 25 seen in FIG. 2. The interaction of the DSO lever 38 with the steam sensing arrangement 25 will be described in more detail below with reference to FIGS. 9c and 11.

FIG. 3b shows a front view of the plunger 58. The first latch 32a and the first piston 36a can be seen in FIG. 3b, together with the second latch 32b and the second piston 36b. The first piston 36a extends radially from an outer surface of the first latch 32a (in the first direction). The second piston 36b extends radially from an outer surface of the second latch 32b (in the second direction).

Although not shown in FIGS. 2a and 2b, the first piston 36a and the second piston 36b extend into the first and second main spring chambers 56a respectively. This can be seen more clearly in FIG. 9e. The first main spring 34 is threaded around the first piston 36a such that a portion of the spring 34 extends above the first piston 36a, towards the lid 5 of the appliance 1, while the remainder of the first main spring 34 extends between the lower surface of the first piston 36a and a base of the first main spring chamber 56a.

FIG. 3c shows a cross-sectional side view of the manual intervention part (in this embodiment, push button) 40 of the appliance 1 seen in FIG. 1.

The manual push button 40 of the plunger 58 defines a central circular groove 40a in which a circular inner button 41 is moveably mounted. The base of the circular groove 40a defines a central circular aperture 40b and three secondary apertures 40c, extending around the circumference of the circular aperture 40b.

The inner button 41 comprises three hooked portions 41a that extend perpendicularly from the underside of the inner button 41 to pass vertically through the three secondary apertures 40c respectively towards the shaft 50. The lower ends of the hooked portions 41a protrude radially outwards and are arranged to engage with the underside of the base of the circular groove 40a when the inner button 41 is in a raised position (as shown in FIG. 3c). This means that downwards movement of the manual push button 40 causes the inner button 41 to move down correspondingly. However, the inner button 41 can be pushed down independently of the manual push button 40 during a manual intervention, as described below in relation to FIG. 13.

The supporting member 48 is fixedly mounted to the upper end of the shaft 50. The supporting member 48 comprises three radially protruding lobes 48a which extend to rest upon an upper surface of the shaft sleeve 51. The plunger 58 further comprises a plate biasing member (in this embodiment, a compression spring) 46 that extends through the central circular aperture 40b, between the underside of the inner button 41 and the supporting member 48. Thus, the compression spring 46 acts to bias the shaft 50 downwards and the inner button 41 upwards (i.e. in opposite directions).

From this arrangement, it will be appreciated that a downwards force on the manual push button 40 results in a downwards force on the inner button 41 (owing to the engagement between the hooked portions 41a and the underside of the base of the circular groove 40a), as well as a downwards force on the shaft 50 (owing to the force transferred to the supporting member 48 via the spring 46) and a downwards force on the shaft sleeve 51 (owing to the force transferred to the shaft sleeve 51 by the lobes 48a of the supporting member 48).

Thus, the shaft 50 and the shaft sleeve 51 are moved downwards as one when the manual push button 40 is pressed down to move the heating plate 6 back to its heating position. This will be described later with reference to FIGS. 14a and 14b.

Furthermore, it will also be appreciated from the above-described arrangement that, owing to the engagement between the upper surface of the shaft sleeve 51 and the lobes 48a of the supporting member 48, upwards movement of the shaft sleeve 51 results in corresponding upwards movement of the shaft 50, as the shaft 50 is lifted by the shaft sleeve 51 via the lobes 48a of the supporting member 48.

Returning to FIG. 1, during use the appliance 1 is placed on an induction hob (not shown). When the induction hob is energised by passing an electrical current through a coil in the induction hob, a magnetic field is induced that passes through the ferromagnetic heating plate 6, causing the temperature of the heating plate 6 to rise. The shape of the magnetic field induced by the circular induction coil in the induction hob is substantially toroidal, with the centre of the magnetic field located at the centre-point of the induction coil. Thus, the outer portions of the heating plate 6, which are exposed to the magnetic field (when the appliance 1 is placed centrally on the induction hob), experience greater heating than the central unexposed region.

FIG. 4 shows a schematic heat map for the non-circular heating plate 6 of the appliance 1 shown in FIG. 1, if it were to be separated from the appliance 1 and placed centrally on an induction hob. The heating plate 6 comprises a major axis 60 and a minor axis 62. Typical dimensions for the heating plate 6 are a length of about 150 mm along the major axis 60 and a width of about 136 mm along the minor axis 62. The centre C of the induction hob is shown in FIG. 4.

A first less-heated region 6a is located at the centre of the heating plate 6 (at the intersection between the major axis 60 and the minor axis 62). In this arrangement, the centre of the heating plate 6 aligns with the centre C of the induction hob. The first less-heated region 6a is also non-circular, comprising a major axis and a minor axis that are coaxial with the major axis 60 and the minor axis 62 respectively of the heating plate 6.

A heated region 6b of the heating plate 6 is shown by the shaded region of FIG. 4. The heated region 6b extends radially outwards from the first less-heated region 6a in a substantially annular shape. Along the minor axis 62 of the heating plate 6a, the heated region 6b extends from the edge of the first less-heated region 6a to the perimeter of the heating plate 6. However, along the major axis 60 of the heating plate 6a, the heated region 6b does not extend to the perimeter of the heating plate 6. Thus, a second less-heated region 6c and a third less-heated region 6d are respectively defined on either side of the heated region 6b (the left and right hand sides of FIG. 4 respectively) along the major axis 60, between the heated region 6b and the perimeter of the heating plate 6. The heating pattern is substantially symmetrical about the major axis 60 and the minor axis 62 of the heating plate 6.

Thus, it will be seen that the edges of the heating plate 6 along the minor axis 62 of the heating plate 6 experience greater heating than the edges of the heating plate 6 along the major axis 60 of the heating plate 6. This non-uniform heating pattern arises as a result of the non-circular shape of the heating plate 6.

FIG. 5 shows a schematic heat map for the non-circular heating plate 6 of FIG. 4 when placed off-centre on an induction hob. The centre C of the induction hob is shown in FIG. 5. As can be seen, the first less-heated region 6a is now offset from the centre of the heating plate 6 along the minor axis 62 of the plate 6. Correspondingly, the annular heated region 6b is also offset from the centre of the heating plate 6 along the minor axis 62 of the plate 6, so that the heating pattern is no longer symmetrical about the major axis 60 of the plate 6, but continues to be symmetrical about the minor axis 62. The second less-heated region 6c extends across the remaining surface of the heating plate 6.

Depending on where the heating plate 6 is arranged with respect to the induction hob, the heated region 6b could be located anywhere on the heating plate 6. As it is desirable for the DSO mechanism 10 of the appliance 1 to sense the highest temperature of the heating plate 6, so that the appliance 1 can be switched off before any part of the plate 6 reaches an unsafe temperature, the inventors have realised that the variability in the location of the heated region 6b can lead to difficulties in providing a reliable DSO mechanism 10. It would not be desirable for the DSO mechanism 10 to have different response times depending on the placement of the appliance 1 on an induction hob.

In terms of manufacturing and operation of the appliance 1, it is convenient to arrange the DSO mechanism 10 at the centre of the heating plate 6. However, when the appliance 1 is positioned centrally on the induction hob, this arrangement means that the DSO mechanism 10 will not experience the high temperature of the heated region 6b of the heating plate 6, owing to the shape of the heat distribution as illustrated in FIG. 4. Thus, there is a risk that a centrally placed DSO mechanism 10 will not switch off the appliance 1 even when the temperature of the heated region 6b of the heating plate 6 is dangerously high.

Therefore, as seen in FIGS. 6-8, the DSO mechanism 10 of the appliance 1 comprises a thermally conductive heat bridge 12 that is connected in good thermal communication with the upper surface of the heating plate 6 (for example, welded onto the heating plate 6). The heat bridge 12 is configured to conduct heat evenly along its length. In this embodiment the heat bridge 12 is shown as a generally rectangular strip, but it could have other shapes, for example a dog bone shape to overlap more with the heated regions 6b at the edges of the heating plate 6.

FIG. 6 shows a schematic heat map for the non-circular heating plate 6 of FIG. 1, comprising the heat bridge 12, when placed generally centrally on an induction hob. The centre C of the induction hob is shown in FIG. 6.

The heat bridge 12 extends along the minor axis 62 of the heating plate 6. Thus, when the appliance 1 is placed generally centrally on the induction hob, the heat bridge 12 is arranged to extend between the areas of the plate that are most heated (i.e. the furthest portions of the heated region 6b along the minor axis 62 of the plate 6), as discussed above with reference to FIG. 4. As a result, a high temperature gradient exists along the heat bridge 12 between the most heated regions of the plate 6 and the centre of the plate 6, meaning that heat is transferred to the centre of the plate 6 effectively. This positioning of the heat bridge 12 takes advantage of the non-uniform heat distribution caused by the non-circular shape of the heating plate 6 by ensuring that the edges of the heat bridge 12 are arranged on the heating plate 6 so as to experience the greatest induction heating effect.

When the DSO mechanism 10 is arranged at the centre of the heating plate 6, as it is shown in FIG. 1, the heat bridge 12 serves to transfer heat to the DSO mechanism 10. This reduces the risk of the DSO mechanism 10 failing to interrupt induction heating of the appliance 1 when the temperature of the heated region 6b of the heating plate 6 exceeds an allowable threshold.

Heating of the liquid within the liquid vessel 2 of the appliance 1 can cause a layer of vapour to become trapped in an area between the base 3 of the vessel 2 and the lower side of the heating plate 6. The vapour layer can act to insulate the heating plate 6 from the liquid within the liquid vessel 2, which can cause the temperature of the lower side to increase rapidly, while the temperature of the rest of the plate 6 and the temperature of the liquid remain relatively low. This can cause the DSO mechanism 10 to interrupt induction heating of the appliance 1 before the liquid within the appliance 1 is brought to boiling point.

Thus, the heating plate 6 defines an array of apertures (i.e. through-holes) 64 which extend circumferentially around the centre of the heating plate 6 in this embodiment. The apertures 64 are positioned around the centre point C where the thermally sensitive actuator will be mounted on the heat bridge 12. The holes 64 allow vapour produced beneath the heating plate 6 to escape upwards into the main volume of the liquid vessel 2 above the heating plate 6, thereby reducing the risk of an insulating layer developing.

FIG. 7 shows a schematic heat map for the non-circular heating plate 6 of FIG. 1, comprising the heat bridge 12, when placed off-centre on an induction hob. The centre C of the induction hob is shown in FIG. 7. In this configuration, the heated region 6b of the heating plate 6 extends through the centre of the heating plate 6 and, thus, beneath the DSO mechanism 10 of the appliance 1. The DSO mechanism 10 is therefore able to sense the highest temperature of the heating plate 6 directly, rather than via the heat bridge 12. However, the temperature of the heated region 6b at the centre of the plate 6 may be limited to a degree by the presence of the holes 64 which reduce the amount of induction heating.

It will be understood from FIGS. 6 and 7 that the heat bridge 12 is most effective when the appliance 1 is placed centrally on the induction hob, as it is in this scenario that the DSO mechanism 10 of the appliance 1 is unable to directly sense the highest temperature of the heating plate 6 and must rely on the heat bridge 12 conducting heat from the edges of the heating plate 6 towards the centre. This is also likely to be the most common placement of the appliance 1 by a typical user, who will tend to position the appliance 1 centrally on the induction hob.

For a heating plate having a major axis length of about 150 mm, the width of the heat bridge 12 is between 16 mm and 24 mm (e.g. about 18 mm). This width is wide enough to allow the heat bridge 12 to collect a large amount of heat from the heating plate 6, yet not so wide that the heat is dissipated before it reaches the central DSO mechanism 10.

FIG. 8 shows a cross-sectional perspective view of the dry switch off (DSO) mechanism 10 of the appliance 1 seen in FIG. 1.

As discussed above, the DSO mechanism 10 comprises a copper heat bridge 12 that extends along the minor axis of the heating plate 6. The DSO mechanism 10 further comprises a mounting plate 18 that is welded to a lower end of the hollow shaft 50 and to the upper surface of the heat bridge 12. An intermediary mechanism (in this embodiment, a rigid rod) 16 is movably arranged within the hollow shaft 50 and extends through an aperture in the mounting plate 18. A circular polymer or ceramic bead 20 is fixedly mounted around a lower end of the rod 16 and engages with an upper surface of the mounting plate 18 to act as a stop for the rod 16, thereby maintaining a predetermined distance between the lower end of the rod 16 and the upper surface of the heat bridge 12. The bead 20 also acts to centre the rod 16 within the shaft 50.

The DSO mechanism 10 further comprises a thermally sensitive actuator in the form of a snap-action bimetallic actuator 14. The actuator 14 is mounted on the heat bridge 12 and is located above the centre of the heating plate 6. The actuator 14 is therefore mounted in thermal communication with the ferromagnetic heating plate 6 and configured to detect when the temperature of the heating plate 6 exceeds a predefined temperature. The rod bead 20 acts as a seal to prevent liquid from travelling through the shaft 50 into contact with the bimetallic actuator 14. The appliance 1 may comprise a similar sealing component arranged at the upper end of the plunger 58 to prevent liquid from entering the shaft 50. The actuator 14 and the heat bridge 12 are arranged on the upper surface of the heating plate 6, rather than the lower surface, so as to allow the heating plate 6 to be positioned as close as possible to the base 3 of the vessel and hence to the induction hob during operation of the appliance 1. The actuator 14 is arranged such that, once it reaches a specific, predefined temperature (typically chosen to be between 125° C. and 140° C.), it snaps, thereby deflecting a free end of the bimetallic actuator 14 upwards, away from the heat bridge 12.

The free end of the actuator 14 is arranged below the lower end of the rod 16 such that, when the actuator 14 snaps and the free end of the actuator 14 is moved upwards, the free end of the actuator 14 abuts the lower end of the rod 16 to push the rod 16 upwards. Thus, with this movement, the free end of the actuator 14 lifts the rod 16 relative to the shaft 50 and the mounting plate 18. The free end of the actuator 14 is arranged to move by a distance of approximately 2.1 mm with its snap action. Thus, the rod 16 is moved upwards accordingly (e.g. by between approximately 1.1 mm and 1.5 mm).

FIG. 8 shows the positons of the actuator 14 and the rod 16 before the predefined temperature of the actuator 14 has been reached. In this configuration, the free end of the actuator 14 is approximately 0.7 mm-1 mm from the base of the rod 16. This distance is maintained by the engagement of the rod bead 20 with the upper surface of the mounting plate 18 and allows for a small amount of creep in the bimetallic actuator 14, which will occur as the temperature of the actuator 14 increases, but is sufficiently small that the deflection of the actuator 14 when it snaps still acts to lift the rod 16.

The casing 52 is welded to the upper surface of the heating plate 6 and the outer surface of the shaft 50 so as to cover the heat bridge 12, the mounting plate 18, the bimetallic actuator 14 and the lower end of the shaft 50. The casing 52 seals the DSO mechanism 10 from the liquid within the liquid vessel 2 to ensure reliable operation of the bimetallic actuator 14.

FIG. 9a shows a cross-sectional side view of the appliance 1 seen in FIG. 1 with the heating plate 6 lifted away from the base 3 of the appliance 1. As can be seen, the armature 28 is in its pivoted position (with the upper end 28a of the armature 28 moved towards the centre of the steam chamber 22).

FIG. 9b shows the appliance 1 after the plunger 58 has been pushed to move the heating plate 6 downwards towards the base 3 of the appliance 1. In this position, the inclined surface 49 at the upper end of the shaft sleeve 51 is brought into contact with, and pushes against, the upper end 28a of the armature 28, causing the upper end 28a to move away from the centre of the steam chamber 22 to rest on the bimetallic steam sensor 26. Pushing down the plunger 58 therefore primes the steam sensing arrangement 25 ready for the appliance 1 to be used. The lifting mechanism 7 is now in a latched configuration with the heating plate 6 lowered in a heating position. A user can fill the vessel 2 with water and place the appliance 1 on an energised induction hob to commence heating. Of course the heating plate 6 may be pushed down to the heating position either before or after placing the appliance 1 on the hob.

As seen in FIG. 9a, the armature 28 is initially in a pivoted configuration, meaning that the latch arm 30 has been moved away from the centre of the steam chamber 22. This means that, as the plunger 58 is moved downwards, the first and second latches 32a, 32b can move past the latch arm 30 without engaging with the latch arm 30. With further downwards movement of the plunger 58, the inclined surface 49 of the shaft sleeve 51 is brought into contact with the upper end 28a of the armature 28. The inclined surface 49 of the shaft sleeve 51 pushes the upper end 28a of the armature 28 away from the centre of the steam chamber 22 to rest against the bimetallic steam sensor 26. This “resets” the position of the armature 28. As discussed above, the latch arm 30 is moved with the lower end 28b of the armature, and is thus moved towards the centre of the steam chamber 22.

As seen in FIG. 9b, at the lowest position of the plunger 58, the feet 54 of the heating plate 6 engage with the base 3 of the liquid vessel 2. When the user releases the downwards force on the manual push button 40, the plunger 58 is moved upwards by the biasing force of the main springs 34 (into the position shown in FIGS. 9c-e) until the first and second latches 32a, 32b engage with the latch arm 30 (as shown in FIG. 9d). The appliance 1 is now primed for heating.

FIGS. 9c and 9d show first and second cross-sectional side views of the appliance seen in FIG. 1, with the lifting mechanism 7 in a latched configuration and the heating plate lowered in a heating position. The cross-section shown in FIG. 9c is in a plane through the centre of the appliance 1. The cross-section shown in FIG. 9d is in a plane that is slightly offset from the centre of the appliance 1.

In the heating position, the heating plate 6 is adjacent the base 3 of the appliance 1. The heating plate 6 comprises separators (in this embodiment, in the form of feet) 54 that project from the underside of the heating plate 6 towards the base 3 of the vessel 2, providing a uniform clearance of about 1 mm between the underside of the heating plate 6 and the upper surface of the base 3. Although it is beneficial for reasons of induction efficiency for the heating plate 6 to be positioned as close to the induction hob as possible during heating, this clearance of 1 mm allows liquid to flow around the heating plate 6. This increases the surface area of the heating plate 6 that is in contact with liquid and encourages convection within the liquid in the liquid vessel 2.

FIG. 9c shows the armature 28 of the lifting mechanism 7 in the initial “latched” position, before deflection of the bimetallic steam sensor 26. The DSO lever 38 is pivoted down, out of contact with the lower end 28b of the armature 28. In FIG. 9d, the second cross-sectional side view shows the interaction of the armature 28 with the latch arm 30, also arranged within the steam chamber 22. The steam chamber housing and a number of other components have been removed for ease of illustration.

The first latch 32a, as seen previously in FIGS. 3a and 3b, is shown in FIG. 9d. The latch arm 30 is shaped to engage with both the first latch 32a and the second latch 32b (not shown in the cross-section of FIG. 9d) so as to prevent vertical movement of the plunger 58 upwards, away from the base 3. When the latch arm 30 is pivoted by the movement of the armature 28 as a result of deflection in the bimetallic steam sensor 26, the latch arm 30 is brought out of engagement with the first and second latches 32a, 32b (thereby allowing vertical movement of the plunger 58 away from the base 3 of the appliance 1, as described further below).

FIG. 9e shows a cross-sectional front view of the appliance 1 seen in FIG. 1 with the lifting mechanism 7 in the latched configuration and the heating plate 6 in the heating position.

In FIG. 9e, the lifting mechanism 7 is latched such that the plunger 58 is held with the heating plate 6 lowered so that the feet 54 of the heating plate 6 abut the base 3 of the liquid vessel 2. In this latched configuration, the respective lower portions of the main springs 34 are compressed by the first and second pistons 36a, 36b and thus exert a biasing force on the first and second pistons 36a, 36b that acts to bias the pistons 36a, 36b and, consequently, the plunger 58, upwards away from the base 3. However, it will be recalled from FIG. 9d that, in the latched configuration as shown, the plunger 58 is prevented from moving vertically upwards by the engagement between the first and second latches 32a, 32b and the latch arm 30.

FIG. 9e also shows the arrangement of the DSO mechanism 10 when the appliance 1 is operating normally with the heating plate 6 in the heating position. As can be seen, in this latched configuration, the bead 20 that surrounds the lower end of the rod 16 abuts the upper surface of the mounting plate 18, indicating that the DSO bimetallic actuator 14 has not deflected.

Operation of the appliance 1 during boiling will now be described with reference to FIGS. 9c-9e.

When a current is passed through the coil in the induction hob, a magnetic field is generated that passes through the ferromagnetic heating plate 6. The heating plate 6 is heated as it is exposed to the magnetic field. As a result, the temperature of the liquid within the liquid vessel 2 that is in contact with the heating plate 6 begins to rise.

When the temperature of the liquid reaches boiling point, the liquid is evaporating into steam, which flows into the steam chamber 22 via the steam inlet 24. As the steam flowing into the steam chamber 22 passes over the bimetallic steam sensor 26 (seen in FIG. 9c), heat from the steam is transferred to the bimetallic sensor, causing the temperature of the bimetallic sensor 26 to rise.

As described above, when the temperature of the bimetallic sensor 26 reaches the predefined temperature (e.g. 85° C.), the bimetallic sensor 26 deflects, thereby causing the armature 28 to pivot. As a result of this movement of the armature 28, the lower end 28b of the armature 28 is pivoted radially outwards away from the shaft sleeve 51. This causes the latch arm 30 to pivot out of engagement with the first and second latches 32a, 32b.

Consequently, the plunger 58, which is biased upwards by the force of the compressed lower portions of the main springs 34, is no longer prevented from moving upwards. Thus, the main springs 34 push the first and second pistons 36a, 36b and, thus, the plunger 58 and heating plate 6 move upwards away from the base 3 of the vessel 2 to a non-heating position as shown in FIGS. 10a-c. The appliance 1 therefore operates to automatically interrupt the induction heating when boiling is sensed, without any manual intervention being required to operate the lifting mechanism 7 or lift the whole appliance 1 off the hob.

FIGS. 10a and 10b show first and second cross-sectional side views of the appliance seen in FIG. 1, after the heating plate 6 has been lifted by operation of the steam sensing arrangement 25 on the lifting mechanism 7, as described above. The cross-section shown in FIG. 10a is in a plane through the centre of the appliance 1 (i.e. the same plane as FIG. 9c). The cross-section shown in FIG. 10b is in a plane that is slightly offset from the centre of the appliance 1 (i.e. the same plane as FIG. 9d).

As can be seen in FIG. 10a, the heating plate 6 has been lifted away from the base 3 of the vessel 2 by the force of the main springs 34 acting on the first and second pistons 36a, 36b to a non-heating position. This means that the heating plate 6 is no longer sufficiently exposed to the magnetic field generated by the induction hob, so the heating plate 6 is no longer heated by induction. This prevents the appliance 1 (i.e. the heating plate 6) from continuing to heat (i.e. boil) the liquid within the liquid vessel 2 after boiling has been detected by the bimetallic steam sensor 26.

The armature 28 of the lifting mechanism 7 is shown in its pivoted position, in which the upper end 28a of the armature 28 has been pivoted towards the shaft sleeve 51 and the lower end 28b of the armature 28 has been pivoted away from the shaft sleeve 51, thereby acting on the latch arm 30 so that the latch arm 30 (seen in FIG. 10b) has pivoted out of engagement with the first and second latches 32a, 32b. This allows the shaft sleeve 51, on which the first and second latches 32a, 32b are arranged, to move upwards into the position as shown in FIGS. 10a-c. The pivoted position of the latch arm 30 is shown in FIG. 10b, in which the steam chamber housing and a number of other components have been removed for ease of illustration.

FIG. 10c is a cross-sectional front view of the appliance 1 and shows the extension of the lower portions of the main springs 34 after the first and second latches 32a, 32b have been released from engagement with the latch arm 30. The upper portions of the main springs 34, which extend above the first and second pistons 36a, 36b, are shown in compression. The upper portions of the main springs 34 are arranged to abut an upper wall of the steam chamber housing 56 when the first and second latches 32a, 32b are released and the first and second pistons 36a, 36b are permitted to rise with the plunger 58. This provides a damping mechanism (i.e. the upper portions of the main springs 34) that reduces the impact of the first and second pistons 36a, 36b against the upper wall of the steam chamber housing 56 when the first and second latches 32a, 32b are released, thus softening the deceleration of the plunger 58 as it reaches a maximum height. This helps to improve the user's experience and safety and to prolong the lifetime of the components of the appliance 1.

FIG. 10c also shows the arrangement of the DSO mechanism 10 when the heating plate 6 has been lifted by operation of the steam sensing arrangement 25 on the lifting mechanism 7. The bead 20 that surrounds the lower end of the rod 16 continues to abut the upper surface of the mounting plate 18, as the bimetallic actuator 14 of the DSO mechanism 10 has not deflected.

In an alternative scenario to the one described in relation to FIGS. 9-10, the appliance 1 is placed on an energised induction hob without any liquid present in the vessel 2. FIG. 11 shows a cross-sectional side view of the appliance seen in FIG. 1 when the heating plate 6 is lowered in the heating position and at the moment when the DSO mechanism 10 has been triggered.

In FIG. 11, the heating plate 6 has been returned to the heating position, in which the feet 54 of the heating plate 6 abut the base 3 of the liquid vessel 2. Thus, when the appliance 1 is placed on an induction hob and the induction coil is energised, the temperature of the heating plate 6 begins to increase, as described above. The heat bridge 12 is arranged to conduct heat from the edges of the heating plate 6 towards the DSO bimetallic actuator 14, causing the temperature of the actuator 14 to increase.

Before the temperature of the DSO bimetallic actuator 14 reaches its predefined temperature, the DSO mechanism 10 is configured as shown in FIG. 8; the bead 20 that surrounds the lower end of the rod 16 abuts the upper surface of the mounting plate 18, as the free end of the DSO bimetallic actuator 14 has not yet been deflected upwards away from the base 3 of the appliance 1.

When the temperature of the bimetallic actuator 14 reaches its predefined temperature, the actuator 14 deflects such that the free end of the actuator 14 is moved upwards, away from the base 3 of the appliance 1. As a result, the free end of the actuator 14 abuts the lower end of the rod 16 and lifts the rod 16 vertically, within the shaft 50, upwards away from the base 3 of the vessel 2. This is shown in FIG. 11. As can be seen, the rod 16 is lifted such that the bead 20 no longer rests on the upper surface of the mounting plate 18. Instead, the lower end of the rod 16 rests on the free end of the DSO bimetallic actuator 14.

FIG. 11 shows how the DSO lever 38 has been acted on by the rod 16 to pivot upwards from the position shown in FIG. 9c. The DSO lever 38 is substantially triangular in cross-section, comprising a first lobe that extends in a first direction along an axis, a second lobe that extends in the opposite direction along that axis, and a third lobe that extends perpendicularly from the axis along which the first and second lobes extend. As seen in FIG. 11, the first lobe 38a protrudes from the shaft 50 towards the lower end 28b of the armature 28 (through an aperture in the shaft sleeve 51), the second lobe 38b extends into the shaft 50 to abut the upper end of the rod 16, and the third lobe 38c protrudes from the shaft 50 (through the aperture in the shaft sleeve 51) towards the base 3 of the liquid vessel 2.

The DSO lever 38 is pivotally mounted (directly or indirectly) on the shaft 50 of the plunger 58. When the rod 16 is lifted by deflection of the DSO bimetallic actuator 14, the upper end of the rod 16 pushes against the underside of the second lobe 38b of the DSO lever 38, causing the DSO lever 38 to rotate in an anti-clockwise direction. As a result, the first lobe 38a of the DSO lever 38 pushes against the lower end 28b of the armature 28, thereby causing the armature 28 to pivot away from the sleeve 51 and move the lifting mechanism 7 out of the “latched” configuration into the “unlatched” configuration. The third lobe 38c of the DSO lever 38 acts as a stop to prevent the DSO lever 38 from rotating too far, by engaging with the outer surface of the shaft sleeve 51.

FIG. 11 shows the “unlatched” configuration of the armature 28 and the DSO lever 38 in the lifting mechanism 7. As discussed above, the pivoting of the armature 28 causes the lower end 28b of the armature 28 to move the latch arm 30 out of engagement with the first and second latches 32a, 32b. Consequently, the plunger 58 is then free to be lifted by the force of the compressed main springs 34, in the same way as described above with reference to FIGS. 9a-10c. This moves the heating plate 6 to a non-heating position away from the magnetic field of the induction hob, thereby preventing further heating of the heating plate 6 and the liquid within the liquid vessel 2.

It will be appreciated, therefore, that the DSO lever 38 translates the movement of the rod 16, caused by operation of the DSO mechanism 10, into a pivoting movement of the armature 28 that unlatches the first and second latches 32a, 32b. This means that the same lifting mechanism 7 (i.e. the armature 28, the latch arm 30, the first and second latches 32a, 32b and the main springs 34) is used to lift the heating plate 6 regardless of whether the lifting is triggered by the steam sensing arrangement 25 or the DSO mechanism 10. Using a single lifting mechanism 7 for both steam switch-off and dry switch-off greatly reduces the complexity of the appliance 1 while increasing its safety.

FIG. 12 shows a cross-sectional side view of the manual push button 40 of the appliance 1 seen in FIG. 1. This view is similar to that shown in FIG. 3c, but the cross-section is taken along a different plane. In this cross-sectional view, it can be seen that the inner button 41 further comprises an extension arm 42 that extends perpendicularly from the underside of the inner button 41, parallel with the hooked portions 41a. The extension arm 42 extends through an extension aperture 40d defined in the base of the circular groove 40a, past the supporting member 48. When the lifting mechanism is in the “latched” configuration, the extension arm 42 extends into the steam chamber of the appliance 1.

FIG. 13 is a wider view of the cross-sectional side view shown in FIG. 12, after the manual intervention part (i.e. the inner button 41) has been operated. During heating of the heating plate 6 by an induction hob, the appliance 1 can be manually operated to interrupt induction heating by the user by pushing down on the inner button 41. As the inner button 41 is moved downwards against the bias of the compression spring 46, the extension arm 42 of the inner button 41 slides along a protrusion 44 that is provided on an outer surface of the shaft sleeve 51. At the base of the protrusion 44, the surface of the protrusion is inclined so that the protrusion 44 projects towards the lower end 28b of the armature 28. Thus, when the extension arm 42 reaches the base of the protrusion 44, the extension arm 42 is deflected radially outwards and thus pushes against the lower end 28b of the armature 28. This causes the armature 28 to pivot, thereby bringing the latch arm 30 out of engagement with the first and second latches 32a, 32b and allowing the unlatched lifting mechanism 7 to operate so that the plunger 58 and the heating plate 6 are lifted by the main springs 34.

Thus, the extension arm 42 of the inner button 41 translates the movement of the inner button 41 into a pivoting movement of the armature 28. It will be appreciated that the same lifting mechanism 7 (i.e. the armature 28, the latch arm 30, the first and second latches 32a, 32b and the main springs 34) that is used to lift the heating plate 6 when the lifting is triggered by the steam sensing arrangement 25 or the DSO mechanism 10, also serves to lift the heating plate 6 when manual intervention is initiated by pushing down the inner button 41.

The compression spring 46 ensures that the inner button 41 is returned to the position shown in FIG. 12 once the user has ceased to apply pressure to the button 41.

After the heating plate 6 has been lifted to the non-heating position seen in FIGS. 10a-10c, whether as a result of the detection of boiling by the steam sensing arrangement 25, the detection of a “dry boil” scenario by the DSO mechanism 10, or as a result of a manual intervention as described above, the appliance 1 must be reset in order for further heating of liquid within the liquid vessel 2 to take place. The lifting mechanism 7 is reset by lowering the plunger 58 and, thus, the heating plate 6 so that the heating plate 6 is adjacent the base 3 of the vessel 2 in its heating position again. This is shown in FIG. 14a.

In order to lower the plunger 58, the user pushes down on the manual push button 40. As described above, this causes the plunger 58 and its related components to move downwards towards the base 3 as one, against the opposing biasing force of the lower portions of the main springs 34, which are compressed by this movement (as seen in FIG. 9e).

The plunger 58 is moved downwards until the feet 54 of the heating plate 6 abut the base 3 of the vessel 2, as shown in FIGS. 14a and 14b. When the feet 54 of the heating plate 6 contact the base 3, the shaft 50 is pushed upwards against the bias of the compression spring 46. This ensures that the heating plate 6 is firmly pressed into a heating position close to the base 3 of the vessel 2, thereby ensuring that the desired distance of 1 mm is maintained therebetween. The spring 46 is seen to be over-compressed in FIG. 14a when a user is applying downwards pressure to the manual push button 40. When this pressure is released, the spring 46 relaxes to its natural length (as seen in FIG. 9c) and the push button 40 lifts away from the lid, with the bias force of the spring 46 acting on the shaft 50 to keep the heating plate 6 lowered in its heating position regardless of any small variations in the vertical distance between the latches 32a, 32b (seen in FIG. 14b) and the base 3 of the vessel 2 (e.g. as a result of variable thickness of the glass base 3).

As the plunger 58 is moved downwards, a lower inclined surface of the first and second latches 32a, 32b pushes against an upper correspondingly inclined surface of the latch arm 30, thereby pivoting the latch arm 30 radially outwards as the first and second latches 32a, 32b move past (see FIG. 14b). Once the first and second latches 32a, 32b have been moved below the latch arm 30, the latch arm 30 is pivotally returned radially inwards by the wire biasing spring (not shown) that acts on the latch arm 30. The lifting mechanism 7 is thereby returned to its latched configuration.

FIG. 14b shows a second cross-sectional side view of the appliance 1 after the plunger 58 has been manually pushed down to reset the appliance 1. This cross-section shows the relative locations of the latch arm 30 and the first latch 32a with the heating plate 6 in its lowest position, in which the feet 54 of the heating plate 6 abut the base 3 of the vessel 2.

In FIG. 14b, it can be seen that there is a gap between the first and second latches 32a, 32b (although the second latch 32b is not shown in this Figure) and the surface of the latch arm 30 against which the first and second latches 32a, 32b engage. When the user ceases to push down on the manual push button 40, the upwards biasing force of the lower portions of the main springs (not shown) acts on the plunger 58 via the first and second pistons (not shown) to lift the plunger 58. This closes the gap between the first and second latches 32a, 32b and the latch arm 30 and brings these components into “latching” engagement, in which the plunger 58 is prevented from further upwards movement. Thus, the lifting mechanism 7 is returned to the “latched” configuration as shown in FIGS. 9c-9e.

In the embodiment described above, it can be seen that the lifting mechanism 7 comprises the plunger 58 which mounts the heating plate 6 inside the vessel 2. The lifting mechanism 7 is conveniently arranged to move relative to the lid 5. The lid 5 can be removed while leaving the lifting mechanism 7 in position, or the entire lifting mechanism 7 can be removed from the liquid vessel 2 (e.g. with the lid 5) for ease of cleaning of the appliance 1 and its various components.

FIG. 15 shows an underside view of a liquid heating appliance 101 in accordance with another embodiment of the invention.

The appliance 101 is substantially similar to the appliance 1 shown in FIG. 1, except for the differences described below. The appliance 101 comprises a transparent glass housing that defines a liquid vessel 102. The appliance 101 further comprises a ferromagnetic heating plate 106, mounted within the liquid vessel 102 by a lifting mechanism (not shown) in substantially the same way as the heating plate 6 seen in FIG. 1.

The heating plate 106 comprises four feet 154 (embodying “separators”) that project from the underside of the heating plate 106 towards the base of the vessel 102, thereby providing a uniform clearance of about 1 mm between the underside of the heating plate 106 and the upper surface of the base. Apertures 164 defined in the heating plate 106 allow for fluid communication between the underside of the heating plate 106 and the upper side of the heating plate 106, thereby helping to improve convection in the appliance 101.

In contrast to the feet 54 of heating plate 6 of the appliance seen in FIG. 1, which are positioned adjacent the perimeter of the heating plate 6, the feet 154 of the heating plate 106 are positioned more centrally, within the inner half of the area of the heating plate 106.

FIG. 16 shows a schematic heat map for the heating plate 106 of the appliance seen in FIG. 15 when placed centrally on an induction hob. The position of the heat bridge 112 is shown for reference.

The heating plate 106 comprises a major axis 160 and a minor axis 162. The centre C of the induction hob is shown in FIG. 16.

A first less-heated region 106a, a heated region 106b and a second less-heated region 106c are positioned on the heating plate 106 in the same way as described above with reference to FIGS. 4 and 6.

As can be seen, the feet 154 of the heating plate 106 are arranged within first less-heated region 106a, which is radially inwards of the heated region 106b and the second less-heated region 106c. This means that, when the appliance 101 is positioned centrally on an energised induction hob, the feet 154 are not exposed to the region 106b of the heating plate 106 that will be heated to the greatest temperature.

The feet 154 are arranged on the underside of the heating plate 106 such that they are brought into contact with the base of the glass vessel 102 when the heating plate 106 is lowered in its heating position. Thus, the feet provide a thermally conductive path between the heating plate 106 and the glass vessel 102. By positioning the feet 154 in the first less-heated region 106a of the heating plate 106, the thermal energy transferred from the heating plate 106 to the glass vessel 102 can be reduced, thereby reducing the risk of damaging the glass vessel 102 by overheating or thermal shock.

FIG. 17 shows a perspective view of the liquid heating appliance 101 seen in FIG. 15. For clarity, the lifting mechanism and the upper components of the appliance 101 have been removed.

The appliance 101 comprises a stainless steel heating plate cover 109 that is mounted to the upper surface of the heating plate 106. The heating plate cover 109 extends across the entire upper surface of the heating plate 106 and comprises a plurality of apertures 111 that allow fluid communication between the upper side of the heating plate 106 (and the underside of the heating plate 106 via apertures 164 in the heating plate 106) and the liquid volume defined by the glass vessel 102 above the heating plate cover 109. This helps to improve convection in the appliance 101. The provision of the heating plate cover 109 also helps to conceal the heating plate 106 from view by a user of the appliance 101, which may be aesthetically beneficial as the heating plate 106 can become discoloured in use.

The appliance 101 further comprises a silicon bumper ring 113 extending around the perimeter of the heating plate cover 109. The bumper ring 113 helps to prevent the wall of the glass vessel 102 from being damaged by the heating plate 106 as the heating plate 106 moves within the vessel 102. This can reduce the risk of imperfections developing in the wall of the glass vessel 102, which can become points of failure in the glass at high temperatures, e.g. during a dry boil scenario. The bumper ring 113 is mounted to the heating plate cover 109, rather than to the heating plate 106. This helps to protect the bumper ring 113 from heat damage as a result of high temperatures in the heating plate 106.

FIG. 18 shows a perspective view of the underside of the heating plate cover 109. The heating plate has been removed from FIG. 18 for clarity.

As can be seen, the heating plate cover 109 comprises four tangs 115 that extend downwards from the underside of the heating plate cover 109 towards the heating plate 106 around the centre of the heating plate cover 109. The tangs 115 are arranged to engage with corresponding slots 119 in the heating plate 106 (shown in FIG. 15), thereby mounting the heating plate cover 109 to the heating plate 106. The tangs 115 also serve to maintain a separation between the underside of the heating plate cover 109 and the upper side of the heating plate 106, which helps to reduce the conductive flow of thermal energy from the heating plate 106 to the heating plate cover 109 during use of the appliance 101.

The heating plate cover 109 further comprises six outer spacing tabs 117, extending downwards from the perimeter of the underside of the heating plate cover 109 towards the heating plate 106. The outer spacing tabs 117 assist in maintaining the separation between the heating plate cover 109 and the heating plate 106. This separation is approximately 1 mm.

The bumper ring 113 further comprises six rivets 121 that extend through respective apertures 111 in the heating plate cover 109, from the upper surface of the heating plate cover 109 to the underside of the heating plate cover 109. The rivets 121 help to secure the bumper ring 113 to the heating plate cover 109.

FIG. 19 shows a cross-sectional side view of the appliance 101 seen in FIG. 15. It can be seen that the rivets 121 of the bumper ring 113 extend from an upper lip 113a of the bumper ring 113 that is arranged to sit on the perimeter of the upper surface of the heating plate cover 109. The bumper ring 113 extends around the side of, and beneath, the heating plate cover 109 to form a lower lip 113b. Thus, it will be appreciated that the bumper ring 113 comprises a C-shaped cross-section.

Four of the outer spacing tabs 117 extend through respective apertures in the lower lip 113b of the bumper ring 113, thereby helping to secure the bumper ring 113 to the heating plate cover 109. The outer spacing tabs 117 and the rivets 121 together help to ensure that the bumper ring 113 does not become disengaged from the heating plate cover 109 during movement of the heating plate cover 109 within the vessel 102.

As can be seen in FIG. 19, the bumper ring 113 extends radially further outwards than the heating plate 106, meaning that the bumper ring 113 will contact the wall of the glass vessel 102 before the heating plate 106, in the event of any relative lateral movement between the heating plate 106 and the wall of the vessel 102. This helps to protect the glass wall of the vessel 102 from damage.

What is claimed is:

1. A liquid heating appliance for placement upon an induction hob, the appliance comprising:
a liquid vessel;
a ferromagnetic heating plate mounted within the liquid vessel;
a thermally sensitive actuator in thermal communication with the ferromagnetic heating plate and configured to detect when the temperature of the ferromagnetic heating plate exceeds a predefined temperature; and
a lifting mechanism mounting the heating plate and operable to move the heating plate upwards within the liquid vessel in response to the thermally sensitive actuator detecting that the temperature of the heating plate exceeds the predefined temperature.

2. The liquid heating appliance of claim 1, wherein the lifting mechanism comprises a plunger mounting the heating plate at a lower end and a lifting biasing member arranged to act on the plunger at an upper end to move the heating plate upwards when the lifting mechanism operates.

3. The liquid heating appliance of claim 1, wherein the lifting mechanism comprises a latch and a latch release part arranged at the upper end of the plunger, the latch being moved by the latch release part between a latched configuration, wherein the latch is arranged to restrict upwards movement of the plunger, and an unlatched configuration, wherein the latch is arranged to allow movement of the plunger; and
the liquid heating appliance further comprising an intermediary mechanism arranged to be acted on by the thermally sensitive actuator so as to operate the lifting mechanism by moving the latch release part.

4. The liquid heating appliance of claim 3, wherein the intermediary mechanism is arranged inside the plunger.

5. The liquid heating appliance of claim 1, further comprising a steam sensing arrangement arranged to detect when liquid within the liquid vessel reaches boiling and, in response, configured to operate the lifting mechanism.

6. The liquid heating appliance of claim 5, wherein the lifting mechanism comprises:
a or the plunger mounting the heating plate at a lower end; and
a or the latch and a or the latch release part arranged at the upper end of the plunger;
wherein the steam sensing arrangement is arranged at the upper end of the plunger so as to operate the lifting mechanism by moving the latch release part.

7. The liquid heating appliance of claim 1, further comprising a manual intervention part arranged to operate the lifting mechanism of the appliance.

8. The liquid heating appliance of claim 7, wherein the lifting mechanism comprises:
a or the plunger mounting the heating plate at a lower end; and
a or the latch and a or the latch release part arranged at the upper end of the plunger;
wherein the manual intervention part is arranged at the upper end of the plunger so as to operate the lifting mechanism by moving the latch release part.

9. The liquid heating appliance of claim 1, further comprising a plate biasing member arranged to bias the heating plate downwards.

10. The liquid heating appliance of claim 9, wherein the lifting mechanism comprises a or the plunger mounting the heating plate at a lower end and the plate biasing member is arranged to act on the plunger at an upper end to bias the heating plate downwards.

11. The liquid heating appliance of claim 10, wherein the plunger comprises an inner shaft moveable within an outer sleeve surrounding the inner shaft, wherein the plate biasing member is arranged to act on the inner shaft to bias the heating plate downwards, and wherein the lifting mechanism comprises a or the lifting biasing member arranged to act on the outer sleeve to move the heating plate upwards when the lifting mechanism operates.

12-13. (canceled)

14. The liquid heating appliance of claim 1, wherein the heating plate comprises a heat bridge arranged to conduct heat from one or more portions of the heating plate to the thermally sensitive actuator.

15. The liquid heating appliance of claim 14, wherein the thermally sensitive actuator is mounted on the heat bridge on an upper side of the heating plate.

16-18. (canceled)

19. A liquid heating appliance, the appliance comprising:
a liquid vessel;
a ferromagnetic heating plate comprising a major axis and a minor axis; and
a lifting mechanism mounting the heating plate and operable to move the heating plate within the liquid vessel.

20-23. (canceled)

24. A liquid heating appliance for placement upon an induction hob, the appliance comprising:
a liquid vessel;
a ferromagnetic heating plate mounted within the liquid vessel and spaced from a side wall of the liquid vessel; and
a protection component arranged between the ferromagnetic heating plate and the side wall of the liquid vessel.

25. (canceled)

26. The liquid heating appliance of claim 24, wherein the protection component extends around a perimeter of the ferromagnetic heating plate.

27. (canceled)

28. The liquid heating appliance of claim 24, wherein the protection component comprises a heating plate cover mounted to the ferromagnetic heating plate.

29. (canceled)

30. The liquid heating appliance of claim 28, wherein the heating plate cover defines one or more apertures for providing fluid communication between an upper side of the heating plate cover and an underside of the heating plate cover.

31-32. (canceled)

33. The liquid heating appliance of claim 1, wherein the appliance comprises one or more separators arranged between the ferromagnetic heating plate and a base of the liquid vessel.

34. The liquid heating appliance of claim 33, wherein the one or more separators are arranged such that such that, when the appliance is placed on an induction hob and the induction hob is energized to inductively heat the heating plate, the one or more separators are arranged to abut a region of the ferromagnetic heating plate that is less heated than an inductively heated region of the heating plate.

35-43. (canceled)
